(19) United States
(12) Patent Application Publication
(10) Pub. No.: US 2022/0358517 A1
(43) Pub. Date: Nov. 10, 2022

(54) METHOD TO RECOVER NON-RECOGNIZED ERRORS IN AIRCRAFT WEIGHT DETERMINATIONS TO INCREASE WEIGHT AND CENTER OF GRAVITY LIMITATIONS FOR REGULATED AIRCRAFT

(71) Applicant: C Kirk Nance, Keller, TX (US)

(72) Inventor: C Kirk Nance, Keller, TX (US)

(21) Appl. No.: 17/874,414

(22) Filed: Jul. 27, 2022

Related U.S. Application Data
(63) Continuation-in-part of application No. 15/917,149, filed on Mar. 9, 2018, now Pat. No. 11,410,183.
Application No. 15/917,149 is a division of application No. 14/924,332, filed on Oct. 27, 2015, now Pat. No. 10,089,634.

(51) Int. Cl. G06Q 30/00; G01G 19/07

(52) U.S. Cl. CPC G06Q 30/018; G01G 19/07

(57) ABSTRACT

The method obtaining a change to approved weight limits of a regulated aircraft type comprises the steps of determining a difference between a first maximum takeoff weight limit and a second maximum takeoff weight limit and, using the difference between the first maximum takeoff weight limit and the second maximum takeoff weight limit, identifying the second maximum takeoff weight difference as a percentage of the first maximum weight limit. In other embodiments, a second maximum landing weight limit, a second maximum takeoff weight limit, a second zero-fuel weight limit, and a second maximum ramp weight limit, are each identified as a percentage of the first maximum takeoff weight limit.

This application is a continuation-in-part application of U.S. patent application Ser. No. 15/917,149 filed Mar. 9, 2018, which is a divisional application of Ser. No. 14/924,332, filed Oct. 27, 2015.

### BACKGROUND OF THE INVENTION

For safe operation of an aircraft, the weight of the aircraft must be determined prior to take-off Airlines (also referred to as: FAA/Part 121 “Air Carriers”) have strict departure schedules which are maintained to maximize aircraft utilization each day. Today's airline operations typically do not place fully loaded aircraft upon scales as a means to measure the aircraft weight, and the distribution of that weight commonly referred to as the aircraft Center of Gravity (“CG”); prior to an aircraft's departure (“dispatch”) from an airport gate.

On any single day within the United States, airlines average 28,537 departures; where each of these air carriers must determine the weight and CG for each aircraft prior to departure. United States population has progressively become heavier over the years; thereby the individual weight of each passenger on these aircraft has become heavier. Airlines around the world operate on a very strict time-schedules, where even a short departure delay occurring early in the day can have a ripple effect and create scheduling problems throughout the airline's remaining flight schedule. Aircraft load planning is a crucial part of keeping an airline operating on schedule. A scheduled aircraft departure will commence its load planning process up to one year prior to the actual flight. Airlines do not offer ticket sales for a flight, more than twelve months prior to the flight. As each ticket for a scheduled flight is purchased, the average passenger and average checked bag weights are assigned into a computer program, continually updating throughout the year the planned load for that flight. Aircraft have a Maximum Take-Off Weight “MTOW” limitation. Airline load planning procedures use assumptions as to the weight of passengers and baggage loaded onto the aircraft, to stay below the aircraft MTOW limitation.

Aircraft weights are limited by Federal Aviation Administration “FAA” Regulation. The FAA is the Regulatory Authority which regulates the design, development, manufacture, modification and operation of all aircraft operated within the United States, and will be referenced along with the term “Regulatory Authority” to indicate both the FAA and/or any governmental organization (or designated entity) charged with the responsibility for either initial certification of aircraft or modifications to the certification of aircraft. Examples of Regulatory Authorities would include: European Aviation Safety Agency “EASA”, within most European countries; Transport Canada, Civil Aviation Directorate “TCCA”, in Canada; Agencia Nacional de Aviação Civil “ANAC” in Brazil; or other such respective Regulatory Authority within other such respective countries.

FAA Regulations (provided in the Code of Federal Regulations) are the governmental regulations which detail the requirements necessary for an aircraft to receive certification by the Regulatory Authority within the United States. These would be equivalent to such regulations within the Joint Aviation Regulations “JARs” which are used in many European countries.

Title 14 of the Code of Federal Regulations, Part 25 refers to regulations which control the certification of Air Transport Category aircraft (“Part 25 aircraft”.) Part 25 aircraft include most of the commercial passenger aircraft in use today. For example, Part 25 aircraft includes Boeing model numbers 737, 747, 757, 767, 777; Airbus A300, A310, A320, A330, A340, etc. The methods described herein provide the justification basis needed for a Regulatory Authority to allow increases to the aircraft weight limitations and expansion of the aircraft CG limitations, in particular for airlines which do not provide assigned seating for their passenger. The FAA regulations allow for control mechanisms to assure Part 121 air carriers manage aircraft loading procedures to confirm at the completion of the loading process that the aircraft load remains within the aircraft's certified forward and aft CG limits.

In particular:
Title 14—Code of Federal Regulations:
Part 121—695, subparagraph (d)
§ 121.695 Load Manifest: All Certificate Holders
   The load manifest must contain the following information concerning the loading of the airplane at takeoff time:
   (a) The weight of the aircraft, fuel and oil, cargo and baggage, passengers and crewmembers.
   (b) The maximum allowable weight for that flight that must not exceed the least of the following weights:
      (1) Maximum allowable takeoff weight for the runway intended to be used (including corrections for altitude and gradient, and wind and temperature conditions existing at the takeoff time).
      (2) Maximum takeoff weight considering anticipated fuel and oil consumption that allows compliance with applicable en route performance limitations.
      (3) Maximum takeoff weight considering anticipated fuel and oil consumption that allows compliance with the maximum authorized design landing weight limitations on arrival at the destination airport.
      (4) Maximum takeoff weight considering anticipated fuel and oil consumption that allows compliance with landing distance limitations on arrival at the destination and alternate airports.
   (c) The total weight computed under approved procedures.
   (d) Evidence that the aircraft is loaded according to an approved schedule that insures that the center of gravity is within approved limits.
   (e) Names of passengers, unless such information is maintained by other means by the certificate holder.

If an airline is found to be operating a Regulated aircraft with weights in excess of the aircraft's certified weight limitations, that airline is subject to Federal penalties and fines. It is a violation of Federal Law to knowingly operate an aircraft, when the aircraft weight has exceeded any of the Original Equipment Manufacture's (“OEM's”) certified weight limitations.

All air carriers must have FAA approved procedures in place (“an approved schedule”), in which the air carrier will follow such procedures to insure each time an aircraft is loaded, the load will be distributed in a manner that the aircraft CG will remain within the forward and aft CG limitations. The FAA and the specific air carrier develop these procedures, which are often referred to as “loading laws,” and when implemented define how the aircraft is loaded. An accurate determination of the total passenger weight portion of a flight could most readily be accomplished by having a scale located at the entrance to the aircraft door, by which all weight that enters the aircraft would be measured. Though this solution sounds simple; having the measured weight of the passengers and their carry-on items would cause substantial disruption in an airline's daily flight schedule if the aircraft in which the planned load where to have all of the loaded weights measured; to only at moments before the aircraft is scheduled to depart finds the aircraft weight now exceeds the MTOW limitations. An aircraft delay would result and many dissatisfied passengers, which would be required to be removed of their planned flight.

The FAA has established guidelines through the issuance of an Advisory Circular AC No: 120-27E, dated Jun. 10, 2005, “Aircraft Weight And Balance Control”; in which an airline is allowed to determine aircraft weight through the adoption of a “weight and balance control program” for aircraft operated under Title 14 of the Code of Federal Regulations (14CFR) part 91, subparts 121, 125 and 135. Part 121 deals with scheduled air carrier operations, including airlines such as American, Delta, United and Southwest.

The aircraft operator will use approved loading schedules to document compliance with the certificated aircraft weight limitations contained in the aircraft manufacturer's Aircraft Flight Manual (AFM), for the compiling and summing of the weights of various aircraft equipment, fuel and payload weights, along with the AC120-27E weight designations for passengers and baggage. These types of loading schedules are commonly referred to as the Load Build-Up Method (LBUM).

The aircraft LBUM weight determinations are “computed” with the use of guidance from AC120-27E and considered by the FAA as being 100% accurate. The FAA accepts an aircraft weight which is established under an approved weight and balance control program, using the guidance from AC120-27E as to having zero error in the total aircraft weight; not even one pound of error.

AC120-27E defines approved methods to determine the aircraft weight using “weight assumptions” which are independent of any requirement to use scales to measure of the aircraft total weight at dispatch. The fully loaded weight of the aircraft is established through a process of compiling the weights of various payload items based upon FAA approved “designated” average weights, for the varying elements such as passengers, carry-on baggage, checked baggage, crew weight, cargo weight and the weight of fuel loaded; onto a previously measured empty aircraft weight. AC120-27E designates for large aircraft (being aircraft certified to carry more than 70 passengers) approved weight assumption/designation for passengers and baggage as:

| | | |
|---|---|---|
| passenger weight - May-October | 190.0 | lb. |
| passenger weight - November-April | 195.0 | lb |
| checked bag weight | 28.9 | lb |
| checked as “heavy” bag weight | 58.7 | lb |

Historical weather patterns regarding wind velocity and direction, combined with anticipated storm events along scheduled airline routes are also considered when planning the amount of fuel to be consumed during the flight. On the actual day of a flight, typically two hours prior to the departure of that flight, the airline's automated load planning program will transfer this particular flight plan to the desktop computer display of one of the airline's Flight Dispatchers. It is the responsibility of the Flight Dispatcher to then monitor the planned load of this flight as passengers check-in and board the aircraft. The number of passengers and checked bags are input to the load-planning program. Typically this process goes without interruption and the aircraft will dispatch on schedule, as planned. As the aircraft's door closes and the load-plan is closed-out by the Flight Dispatcher, the aircraft weight associated with the “planned load” will always match the aircraft weight associated with the “departure load” as submitted to the FAA; because both are based on the same collection of weight assumptions used in determining the LBUM. Use of an alternate means to physically measure the total aircraft weight, just as the aircraft door closes, and the possibility of the measured aircraft weight not matching the calculated weight of the LBUM, would have the airline facing a potential departure delay, to resolve any difference in the two separate but parallel aircraft weight determinations. This potential for delay in the flight departure on as many as 2,500 daily flights for a single airline, results in the various airlines not willing to take the risk of hundreds of flight delays each day. Many if not most airlines currently dispatch their aircraft under FAA approved LBUM procedures; a method which helps to keep the airlines running on schedule. This also creates an incentive for airlines to continue to use the FAA approved assumed weights, irregardless to whether the assumed aircraft weight determinations are accurate.

Some airlines offer “assigned seating” within the cabin compartment for their passengers. This process not only allows the passenger the assurance that they will have the seat of their choosing, but also allows the airline load planners the knowledge of the exact location within the cabin as to where the weight associated with that passenger and their carry-on items is located. Airlines which do not offer the option of pre-assigned seating must entrust their load planning departments to determine aircraft CG, lacking the knowledge of where the passenger weights will be located within the aircraft cabin. If an aircraft operated with an open-seating policy has in excess of 80% of the seats filled with passengers, the weight distribution shall be assumed equally distributed throughout the cabin. If the same aircraft departs with only 30% of the seats occupied, the airline has no assurance as to where the weight is located throughout the cabin.

Herein are two examples to better illustrate § 121.695 subparagraph (d) mentioned above. The Boeing 737-800 aircraft has a seating configuration for 174 passengers, in which only 52 passengers (30%) were boarded onto the flight, and will be used in the following examples:
Example #1—an air carrier which operates with an “assigned seating” policy can position the 52 passengers (being just 30% of total) and their associate weight, distributed evenly throughout the aircraft cabin; thus assuring the cabin load remains within the forward and aft CG limits. With each passengers assigned a specific seat located within a specific row number, the airline can plan the aircraft load with confidence that the aircraft will be loaded within the aircraft CG limitations.
Example #2—an airline which has an “open seating” policy, there is a possibility that the 52 passengers may all select a seat within the forward section of the aircraft, in order to be seated forward of the aircraft wing and the engine noise associated with those seats located aft of the wing; and to further be able to quickly exit the aircraft upon arrival at their destination. In this scenario where all 52 passengers are seated within the forward ⅓ section of the aircraft, the aircraft CG has the potential of being positioned beyond the certified forward CG limit of the aircraft.

To insure the aircraft CG, as loaded in Example #2 remains within the CG limitations, the FAA will place additional operational restriction, often called “curtailments” to the extreme forward and extreme aft sections of the manufacture's defined CG envelope. The airline which operates with these curtailments must take actions to insure the aircraft remains within these Regulatory Authority imposed “operationally curtailed” CG limitations through methods such as blocking-off the some of the forward and aft rows of the aircraft seating, or to possibly add temporary “ballast” (heavy bags filled with lead pellets) into the forward or aft cargo compartments of the aircraft, to assure these partially loaded flights will remain within the “operationally curtailed” CG limitations. A full description of these curtailments along with the new methods of this invention for relief of these curtailments will be explained later.

The positioning of passenger weight is important to the aircraft flight planning process. The Boeing 737-800 aircraft has an overall length of 129 feet 6 inches, from nose to tail. Considering an airline operation which has the full use of the CG limitations with no curtailments, at the reduced take-off weight of 150,820 lbs., the airline's load planner has but only 42 inches (see FIG. 1.) to position the cabin and cargo compartment loading, from the originally aircraft's certified CG limitations. If the load planner fails to stay within the forward end of this 42-inch window, the CG will be too far forward, where the aircraft may fail to properly rotate for take-off and a subsequent rejected take-off could over-run the length of the airport runway. If the load planner fails to stay within the aft end of the 42-inch window; the CG will be too far aft, where the aircraft may over-rotate at take-off resulting in a tail-strike, or transition into a stall where the aircraft could possibly crash.

Accurate determination of aircraft take-off weight is an important part of load planning in that it not only adds to the safety of each flight it also is an important consideration regarding the overall life limitation of the aircraft. The aircraft weight can be incorrect by as much as 2,000+pounds and a “properly balanced” aircraft will still take-off, using and extra 100 feet of the available 10,000 feet of runway. The additional weight could come from a variety of possible mis-calculations, but typically will not affect the aircraft take-off.

An aircraft is typically supported by plural and in most cases three pressurized landing gear struts. The three landing gears are comprised of two identical main landing gear struts, which absorb landing loads and a single nose landing gear strut used to balance and steer the aircraft as the aircraft taxi on the ground. Designs of landing gear incorporate moving components which absorb the impact force of landing. Moving components of an aircraft landing gear shock absorber are commonly vertical telescopic elements. The telescopic shock absorber of landing gear comprise internal fluids, both hydraulic fluid and compressed nitrogen gas, and function to absorb the vertical descent forces generated when the aircraft lands. While the aircraft is resting on the ground, the aircraft is “balanced” upon three pockets on compressed gas within the landing gear struts.

Monitoring the distribution and subsequent re-distribution of aircraft loads can be identified by measuring changes in the three landing gear strut internal pressures, which will in turn identify the aircraft CG. The implementation of changes to aircraft loading procedures for both the assumptions as to the weight of items loaded onto the aircraft, as well as the location within the aircraft the weights are placed; further combined with strict auditing procedures to identify non-recognized weight errors associated with the weight assumptions; create the justification basis to allow aircraft weight and CG limitations to be modified.

In spite of numerous variations in prior art for aircraft “OBWBS”, only one U.S. airlines currently uses OBWBSs in their daily operations, but instead most major airlines typically use the LBUM to determine aircraft weight.

This invention offers new methods with apparatus to “periodically” measure aircraft weight, in support of re-defined load planning procedures and records-keeping, to create the justification basis for increases in the aircraft weight limitations and an easing of operational CG curtailments for Regulated aircraft.

Additionally, the creation of the justification basis for an increase to weight limitations for Regulated aircraft, to a higher weight limitation equivalent to the amount of the currently allowed statistical error in weight assumptions of the LBUM shall be fully described in the new methods of this invention for relief to weight limitations and CG curtailments and will be explained fully throughout the Figures and Descriptions herein.

It should be noted that the Regulatory Authorities have various practices to provide relief or modification to the regulatory requirements, such as:
Equivalent Level of Safety
Special Condition
Exemption
   This relief is normally granted by the Regulatory Authority, after demonstration and/or analysis of an alternate means of compliance, which verifies compliance with the intent of the regulation, without showing literal compliance to the regulation.

Another aspect of this invention are methods by which Part 121 air carrier operations utilizing “random/open seating” polices are justified in receiving relief from operational CG curtailments caused by aircraft loading assumptions, to an equivalent of the broader CG curtailments of air carrier operations using “assigned seating” policies, whereby the operational CG limitations of a Part 25 aircraft may be increased and acknowledged by aviation Regulatory Authorities. One of the methods of this invention involves analysis of periodically obtained weight and/or CG data from daily airline operations, combined with development and implementation of set of new daily operational requirements for the Part 25 aircraft; thus providing by either: a demonstration and/or analysis to substantiate, a finding of an “Equivalent Level of Safety” and/or “Special Condition”.

The FAA defines and Equivalent Level of Safety (ELOS) as follows:
“Equivalent level of safety findings are made when literal compliance with a certification regulation cannot be shown and compensating factors exist which can be shown to provide an equivalent level of safety.”
{http://rgl.faa.gov/Regulatory_and_Guidance_Library/rgELOS.nsf/}

The FAA issues a finding of ELOS during the process of certification, whether that be the initial certification of an aircraft, certifications of derivative aircraft the manufacturer may develop or when issuing a Supplemental Type Certificate for modifications to an aircraft type, developed by entities other than the manufacturer.

In the case of existing air carrier operations the “literal compliance” with an accurate determination of aircraft weight and CG, which cannot be shown, however the “compensating factors” which exist in this new invention to substantiate the ELOS finding include:
The incorporation of apparatus and methods to measure, periodically record and display (or generate alerts) when defined weight and/or CG thresholds are exceeded and, one or more of the following additional elements:
   The Approved Flight Manual for the aircraft contains specific operationally imposed weight and CG limits with which the aircraft must apply and provides for compliance with the traditional LBUM in determining aircraft total weight, if the ability of the system's periodic sampling of weight and CG becomes inoperative;
   Apparatus and methods for periodically recording aircraft weight and/or CG for a specific sample size of aircraft dispatches in support of a trend monitoring system to monitor the “experienced” aircraft loading; as compared to both the specific load manifest of the periodically weighed aircraft and that of the loading pattern trends of the airline's full fleet of aircraft;
   Alerting to the flight deck crew if the real-time sampled weight and/or CG has exceeded one or more pre-defined thresholds.

The FAA defines Special Condition as follows:
“A Special Condition is a rulemaking action that is specific to an aircraft type and often concerns the use of new technology that the Code of Federal Regulations does not yet address. Special Conditions are an integral part of the Certification Basis and give the manufacturer permission to build the aircraft, engine or propeller with additional capabilities not referred to in the regulations.”
{http://rgl.faa.gov/Regulatory_and_Guidance_Library/rgSC.nsf/}

A requirement for periodic sampling of physically measured aircraft dispatch weight and CG is not referred to in the regulations; therefore a pathway for Special Condition is created.

A Regulatory Authority may wish to approve such installation, use and regulatory relief from such a System, by the issuance of a Special Condition as an alternative to the granting approval established by an ELOS, based upon no regulatory requirement or definition of a System which measures aircraft take-off weight and CG. Regardless of the regulatory approval path used, the System attributes would be the same.

One of the methods of this invention comprises analysis of “statistically generate” random passenger weights with application of potential non-recognized errors in both the average passenger and average baggage weight data, to be further compared to the distinct 190 lb. weight designation to an additionally assumed 50% male/50% female passenger profile boarding onto the aircraft; further combined with development and implementation of set of new daily operational requirements for the Part 25 aircraft; thus providing by either: a demonstration and/or analysis to substantiate, a finding of an “Equivalent Level of Safety” and/or “Special Condition”.

Though the FAA may continue to assume aircraft weight determinations, as computed within the guidance of AC120-27E, to have zero errors in the aircraft weight determination; a statistical evaluation and review of the FAA approved methods finds significant errors in the LBUM weights which remain un-recognized by the FAA. It will be the identification and quantification of these un-recognized weight errors and the ability to absorb these errors into and with the physical measurement of the aircraft weight, that will create a satisfactory justification basis for Regulatory Authorities to allow regulated aircraft to operate at an increased aircraft MTOW limitation; which increased weight limit is equivalent to the difference between the statistical errors of LBUM computed weight to that of the actual measured aircraft weight.

A common finding when physically re-weighing an aircraft to determine the Operating Empty Weight (“OEW”) is that the weight of the empty aircraft never gets lighter, but tends to get heavier over the life of the aircraft. As aircraft age, the insulation within the cabin will retain higher amounts of moisture. Dirt will accumulate on lubricated surfaces; dirt will become embedded within the carpets and seat fabrics. Structural repairs, which consist of doubling-plates, riveted over discovered fuselage cracks, add weight to the aircraft. These weight increases will remain non-recognized for up to the 36 months interval between the aircraft 3-year re-weighing cycles. Some airlines utilize a practice of “fleet average” weighing, where a minimum of 6 aircraft plus an additional 10% of the operating fleet; ie: 56 of a 500 aircraft fleet will be physically re-weighed, where the remaining 444 aircraft will be assumed to have an identical averaged fleet-weight.

The scales used to determine the aircraft OEW are not required to maintain any FAA stipulated accuracy tolerance, other than an FAA requirement that the airline should calibrate the scale according to a scale calibration procedure approved by the scale manufacturer. Errors can often be as high as 0.5%.

To this point, the focus of this new invention has examined the aircraft MTOW limitation. MTOW is one of four aircraft weight limitations that are established in the flight's load planning process for a particular aircraft dispatch, as part of determining a specific aircraft weight limitation using the LBUM process of determining aircraft weight.

The methods described herein are applicable as procedures and practices used to obtain Regulatory Authority approval to amend existing aircraft weight calculation practices for determining other aircraft operating weights including: MRampW, MLW and MZFW. In today's airline operations, other aircraft weight determinations such as: MRampW, MLW and MZFW are all determined using the same foundations of the MTOW, as determined by LBUM computations.

The Maximum Ramp Weight (“MRampW”) is the MTOW plus the weight of the fuel needed to operate the engines while the aircraft taxi along the airport's service ramps, prior to take-off.

The Maximum Landing Weight (“MLW”) is maximum allowable weight at which the aircraft can “plan” to land. The MLW is the MTOW less the amount of weight associated the “planned” fuel consumption for the flight.

The Maximum Zero Fuel Weight (“MZFW”) is the maximum amount of weight less any onboard fuel. The MZFW is used to determine limits as to passengers and payload, which are loaded onto an aircraft. MZFW is the MTOW less the amount of fuel within the aircraft's fuel tanks as measured by the aircraft cockpit fuel indicators.

The Boeing 737-800 is one of the most common commercial aircraft flown worldwide by today's airlines and shall be used as the example aircraft throughout the examples and illustrations in this invention.

### SUMMARY OF THE INVENTION

There is provided a method of operating an aircraft, the aircraft having a first MTOW based upon “assumed as accurate” weights which include: the empty aircraft, fuel within the fuel tanks, passengers and baggage. Statistical substantiations are obtained of the non-recognized weight errors associated with various weights which are assumed correct including: the fleet average weight of the empty aircraft, accuracy of on-board fuel indicators, average passengers and baggage weights. Based upon statistical evidence quantifying the non-recognized weight errors of the loaded aircraft, operating the aircraft at a second MTOW equivalent to the difference between the non-recognized errors to that of the assumed weights, while periodically measuring and recording the weight of the aircraft at dispatch, the second MTOW being greater than the first MTOW. Operating the aircraft at a second MTOW, which is greater by an amount less than the statistical weight errors, based upon the demonstration of the statistical weight errors.

Additionally there is provided a method of operating an aircraft, the aircraft having a first MLW based upon “assumed as accurate” weights which include: the empty aircraft, fuel within the fuel tanks, passengers and baggage. Statistical substantiations are obtained of the non-recognized weight errors associated with various weights which are assumed correct including: the fleet average weight of the empty aircraft, accuracy of on-board fuel indicators, average passengers and baggage weights. Based upon statistical evidence quantifying the non-recognized weight errors of the loaded aircraft, operating the aircraft at a second MLW equivalent to the difference between the non-recognized errors to that of the assumed weights; while periodically measuring and recording the weight of the aircraft at dispatch, the second MLW being greater than the first MLW. Operating the aircraft at a second MLW, which is greater by an amount less than the statistical weight errors, based upon the demonstration of the statistical weight errors.

Additionally there is provided a method of operating an aircraft, the aircraft having a first MFZW based upon “assumed as accurate” weights which include: the empty aircraft, fuel within the fuel tanks, passengers and baggage. Statistical substantiations are obtained of the non-recognized weight errors associated with various weights which are assumed correct including: the fleet average weight of the empty aircraft, accuracy of on-board fuel indicators, average passengers and baggage weights. Based upon the statistical evidence of quantifying the non-recognized weight errors of the loaded aircraft, operating the aircraft at a second MFZW equivalent to the difference between the non-recognized errors to that of the assumed weights, while periodically measuring and recording the weight of the aircraft at dispatch, the second MFZW being greater than the first MFZW. Operating the aircraft at a second MFZW, which is greater by an amount less than the statistical weight errors, based upon the demonstration of the statistical weight errors.

In accordance with another aspect, the step of determining the values of the non-recognized weight errors further comprises the step of statistical verification of the weight errors through analysis with computer programs which generate random passenger weights, and further populate the random weights within the sample aircraft cabin configuration; with random model data further compared to periodic measuring and recording of the actual weight of the fully loaded aircraft, at dispatch.

Additionally there is provided a method of operating an aircraft, the aircraft having a first Regulatory Authority imposed set of operational CG restrictions based assumed potential errors associated with random seating policies for allocating the passengers weights throughout the aircraft cabin. A system is used to periodically measure aircraft CG to verify the airline's proficiency in aircraft loading procedures to further confirm to Regulatory Authorities that the airline's loading practices assure aircraft CG remains within originally certifies CG limitations. Based upon the periodically measured aircraft CG, providing an ongoing verification of airline's loading practices assuring the aircraft loads remains within originally certified CG restrictions, while operating the aircraft at less restrictive operational CG restriction, being equivalent to loading procedures of airlines which use assigned seating. The second operational forward and aft CG restrictions being wider than the first operational forward and aft CG restrictions.

In accordance with another aspect of the present invention, use of an off-aircraft computer, which wirelessly receives aircraft sensor data from an on-aircraft computer, to determine aircraft weight and CG remotely, being off of the aircraft; and for the off-aircraft computer to then wirelessly re-transmit the aircraft weight and CG determinations back to the aircraft, allows for substantial reduction in certification costs for the system software. Regulatory Authorities control the level of certification requirement, which directly related to associated costs required for computers which process data on an aircraft through software programs. Having that software process the data off of the aircraft allows for substantial reduction in certification costs for the off-aircraft system's software.

### BRIEF DESCRIPTION OF THE DRAWINGS

Although the features of this invention, which are considered to be novel, are expressed in the appended claims, further details as to preferred practices and as to the further objects and features thereof may be most readily comprehended through reference to the following description when taken in connection with the accompanying drawings, wherein:

FIG. 1 is a side view of a typical Boeing 737-800 transport category aircraft, with various components of the invention including an on-aircraft computer and an off-aircraft computer residing in a separate building, along with nose and main landing gear of the aircraft deployed and resting on weight measuring ground scales.

FIG. 2 is a side view of a typical aircraft landing gear strut, with various elements of the invention attached to the landing gear strut.

FIG. 3 is a front view of a typical aircraft landing gear strut with additional elements of the invention attached to the landing gear strut.

FIG. 4 is a chart illustrating a typical Load Build-Up Method “LBUM” used by airlines to determine total aircraft weight.

FIGS. 5a and 5b illustrate non-recognized weight errors through a comparison of a fully loaded Boeing 737-800 aircraft, with all 174 passengers assigned the Regulator Authorities' designated weight of 190 pounds per person; to that of 174 statistically generated random passenger weights applied to all 174 seats within the aircraft.

FIG. 6 illustrates the non-recognized weight error of FIGS. 5a and 5b, with the addition of the Regulatory Authorities designated 5 pound per person in additional weight assumption, added to each passenger's weight, for assumed extra winter clothing; and adjusting the Male % to Female % distribution assumptions.

FIG. 7 illustrates a comparison of Regulatory Authorities' designated weights for personal items and carry-on baggage, with the FAA identified 16 lb. applied to each of the carry-on items. Further illustrating a 20% change in assumed allocation applied and assumed 15% error in item weight.

FIG. 8 illustrates an analysis of the Regulatory Authorities' designated checked baggage weight designations, distributed as the Regulatory Authorities' assumed: 33%-zero, 33%-one checked bag, and 33%-one checked bag and one heavy checked bag per passenger baggage allocation; with an assumed 20% error of 4.3 pound per checked bag and 8.8 pound per heavy checked bag error applied, and 20% error is assumed allocation applied.

FIG. 9 illustrates a calculation of the potential of a 2% error in the determination of the weight of the fuel onboard the aircraft, in that typical aircraft fuel weight indicators are allowed and error tolerance of 2%.

FIG. 10 illustrates a calculation of the potential of a 0.5% error in the determination of the empty aircraft weight, in that typical aircraft weighing scales allowed an error up to 0.5% of the measured aircraft weight.

FIG. 11 is an apparatus block diagram illustrating both on-aircraft computer with inputs from strut pressure/temperature and axle deflection sensors, and off-aircraft computer with various software programs for measuring aircraft weight; in accordance with a preferred embodiment of the present invention.

FIG. 12 illustrates the methodology for obtaining Regulatory Authority Approval for the allowance to periodically measure aircraft weight in order to increase a Regulated aircraft's MTOW limitations.

FIG. 13 illustrates the methodology for Regulatory Authority Implementation for the allowance to periodically measure aircraft weight in order to increase a Regulated aircraft's MTOW limitations.

FIG. 14 illustrates the methodology for Regulated Air Carrier Operations to periodically measure aircraft weight in order to increase a Regulated aircraft's MTOW limitations.

### DETAILED DESCRIPTION OF THE PREFERRED EMBODIMENT

In the description herein, the disclosures and all other information of my earlier U.S. Pat. Nos. 5,214,586; 5,548,517; 6,128,951; 6,237,406; 6,237,407; 8,180,504; and 8,543,322 are incorporated by reference.

The present invention utilizes prior art methods to physically measure the weight of an aircraft as it rest on the ground. Parallel measurements of aircraft weight by independent weight sensing features allow for an increase in confidence of the physical weight measurements and further offer cross-verification for physical weight measurement system accuracy.

The present invention utilizes prior art methods to physically measure the Center of Gravity “CG” of an aircraft as it rest on the ground.

In today's airline operations, aircraft MTOW determinations are computed by a Load Build-Up Method, which processes and procedures have remained relatively un-changed for the past 50 years. The FAA has published Advisory Circular AC120-27E offering guidance for an approved method to determine the aircraft weight by “computations” which are independent of any requirement to measure of the weight of a an aircraft fully loaded with passengers. The fully loaded weight of the aircraft is computed by a process of compiling the weights of various payload items based upon FAA “designated” average weights, for the varying elements such as passengers, carry-on baggage, checked baggage, crew weight; along with cargo weight and the weight of fuel loaded; onto a previously measured empty aircraft weight. This method of computing the aircraft weight based on the summing of the various weight elements loaded on to a pre-measured empty aircraft weight is often mentioned as the Load Build-Up Method and in this description shall continue to be referred to as the “LBUM”.

The FAA's AC 120-27E designated weight assumptions/allocations for airline passengers and baggage are:

| | | |
|---|---|---|
| Average passenger weight - summer | 190.0 | lb. |
| Average passenger weight - winter | 195.0 | lb. |
| Average bag weight | 28.9 | lb. |
| Average heavy bag weight | 58.7 | lb. |

On the actual day of a flight, typically two hours prior to the departure of that flight, the flight's automated load planning program will be transferred to the desktop computer display of one of the airline's Flight Dispatchers. It is the responsibility of the Flight Dispatcher to then monitor the planned load of that flight as passengers check-in at the gate. The number of passengers and allocations for checked bags are input to the load-planning program. Typically this process goes without interruption and the aircraft will dispatch on schedule, as planned. As the door of the aircraft is closed and the load-plan is closed-out by the Flight Dispatcher, the “planned load” will always match the “departure load” as submitted to the FAA; because both are based on the same compilation of weight assumptions used in determining the LBUM. Many if not most airlines currently dispatch their aircraft under FAA approved LBUM procedures; a method which helps to keep the airlines on schedule.

Throughout the description herein, examples will be shown for calculations to determine aircraft take-off weight, being a weight that must never exceed the aircraft's certified Maximum Take-Off Weight (“MTOW”) limitations. Other aircraft weight limitations including MLW and MZFW are computed using a derivative the LBUM. Calculation of the “planned landing weight” is determined by subtracting the weight of the fuel, which is planned to be consumed during the flight from the determined aircraft take-off weight. Calculation of the zero-fuel weight is determined by subtracting the weight of the fuel within all fuel tanks, as indicated by the aircraft's fuel indicators, from the determined aircraft take-off weight.

Systems and/or components used and installed on Regulated aircraft are conformed and certified by the FAA and other Regulatory Authorities and typically have “design standards” which are stringent up to a factor of 10⁻⁹ and used in qualification. Ten to the minus 9^{th} (“10⁻⁹”) is the term typically used and has the equivalent of the odds for a failure of no more than one in one billion (1 in 1,000,000,000). When considering the chances or odds of an airline having non-recognized errors in their methods and procedures for determining aircraft take-off weight fall well below the 10⁻⁹ standards.

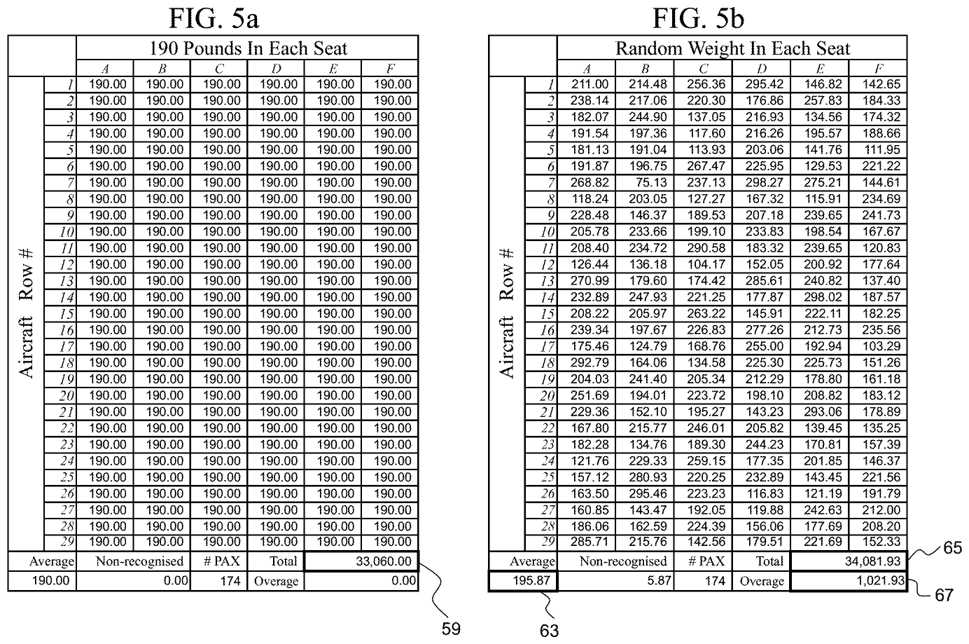

With many daily departures and the associated chances for some type of failure within the airline's LBUM system for determining aircraft weight, the illustration utilized (shown in FIG. 5b) simulates a random generation of 174 simulated passenger weights from a pool of 256,000 randomly generated passenger weights. The random passenger weights were created by the “Random Number Generation Tool” within the Analysis Tool Pack of the Microsoft Office Excel program; where 190 pounds was selected as the “Mean” (representing average weight), and 47 (representing pounds) was selected as the “Standard Deviation” where 265,000 random numbers (the maximum number allowed in the Excel program) are requested. The 265,000 randomly generated passenger weights will fill 174 seats within a total of only 1,471 flights. On any single day there is an average of 28,537 airline departures within the United States,
http://www.natca.org/mediacenter/bythenumbers.msp#1
   thus the example (shown in FIG. 5b) is a random loading of only 1 in 1,471 flights; as opposed to 1 in 28,537 per day of airline flights; or even 1 in 1,000,000,000 being the 10⁻⁹ standard; is a conservative illustration of the potential for error.

The examples shown (in FIGS. 5a and 5b) illustrate and compare the statistical errors associated with the LBUM; without any consideration of the potential for human errors in mis-loading weight values into the LBUM algorythms, which would compound against the statistical errors, to increase the overall weight errors.

An aircraft is typically supported by plural landing gear struts. In many if not most cases, aircraft are supported by three landing gear struts. Each landing gear strut is designed much like, and incorporates many of the features of a typical telescopic shock absorber. The shock absorber of the landing gear strut comprises internal fluids, of both hydraulic oil and compressed gas. More simply said . . . “the weight of an aircraft rests on three pockets of compressed gas.”

As a point of clarification, throughout this description the use of the word “weight” can often be substituted with the use of the word “load” in that some airline operations will seek to avoid any possibility to allow the LBUM determined “take-off weight” of their aircraft be measured; thus referring to loads being applied onto the landing gear struts are often preferred.

The invention herein described will have some portion of all aircraft take-off weights measured as part of the defined processes and procedures to allow for an increase in the MTOW, MLW and MZFW limitations; while those airlines not wanting weight determination but instead desire only relief of CG curtailments will use the determination of “load distribution” features of this invention, without the continued calculations to determine the amount of measured aircraft weight supported.

The average population weight has been documented as becoming heavier year-after-year. For this reason, filled aircraft will (if measured) have a heavier measured weight than the weight computed by population weight data determined in the current FAA/AC120-27E, issued Jun. 10, 2005; which is in use today. Airlines throughout the United States are using this stale weight data in the current 28,537 aircraft dispatches per day.

By measurement of just the loads applied to each landing gear strut and thus transferred as pressure within each landing gear strut, with the further comparison of the load distribution between the combined main landing gear to that of the nose landing gear, the aircraft CG is established, without measuring the weight of the aircraft.

The weight of the aircraft supported by the above mentioned pockets of compressed gas is transferred down the landing gear strut to the landing gear axles, which bear the load and are supported by the landing gear tires. As weight is added to the aircraft, the axles will bend and deflect with the addition of more load. As an alternate means of determining aircraft weight, the bending/deflection of the aircraft landing gear axles can be monitored and measured with such axle deflection being directly proportional to the additional amount of weight added. The deflection of the landing gear axles represent the same load as supported by the pockets on compressed gas, thus both provide methods of determining aircraft weight, which may run parallel.

This invention provides methods of identifying, defining and illustrating a means of justification, for aviation Regulatory Authorities to allow for increases to the weight limitations for Regulated aircraft. The methods described herein develop various strategies including the building of a “justification basis” for increases to MRampW, MTOW, MLW and MZFW limitations; to higher weight limitations, which approved increased weight amounts are less than the amount of non-recognized weight errors in existing operations using the FAA approved guidance of AC120-27E.

Use of prior art aircraft weighing systems are implemented into a Regulatory Authority approved schedule to periodically make aircraft take-off weight measurements, along with unique methods and procedures for the review, analysis and documentation of non-recognizes weight errors, currently allowed in LBUM procedures; which will provide the necessary evidence for Regulatory Authorities' granting weight increases in amounts not exceeding the non-recognized weight errors being allowed today, through a Regulatory Authority's finding of an Equivalent Level Of Safety.

The methods of this new invention further develop strategies for new requirements, for implementation of operational procedures to assure Regulatory Authorities; that allowing the increase in MRampW, MTOW, MLW, and MZFW limitations for Regulated aircraft, will offer an Equivalent Level Of Safety, as an alternative means of Regulatory Compliance.

Regulatory Authorities do not require airlines to weigh aircraft to determine aircraft take-off weight, as a means to confirm aircraft weight limitations have not been exceeded. The procedures implemented in this invention for a defined schedule of pre-take-off aircraft weighings, facilitate the development of a new category of “reliability program” implemented to assure Regulatory Authorities that any increase in aircraft weight limitations shall not be abused nor exceed the non-recognized weight errors currently being allowed. Such periodic fully loaded aircraft take-off weighings will create a Superior Level of Safety, to that of aircraft currently operating with un-measured weights, which un-measured weights allow even further exceedance, beyond of certified weight limitations.

The present invention offers apparatus and methods utilizing a variety of sensors for collecting landing gear load data to continually update a variety of interrelated computer software programs, creating a more advanced aircraft weight measuring system.

To summarize this system, apparatus and methods used for continuous monitoring and measuring by various sensors include:
Strut pressure/temperature sensor
Landing gear strut axle deflection sensor
Aircraft inclinometer
On-aircraft computer to collect aircraft and landing gear data
Off-aircraft computer to process collected landing gear data, with software functionality to determine aircraft weight and CG
Wireless communication capabilities between on-aircraft computer and off-aircraft computer

It is important for any aircraft weighing system to have the ability to accurately determine the aircraft weight before the departure from the gate.

This invention provides methods of identifying, defining and illustrating various means of justification for aviation Regulatory Authorities to allow for increases to the certified aircraft weight and operational CG limitations for Regulated aircraft. The methods described herein develop various strategies in the identification of non-recognized weight errors for a justification basis built upon the statistical demonstration of the long history of these non-recognized weight errors having created no un-safe aircraft operations for fully loaded/weighted aircraft, and to further construct an acceptable reliability program of safe aircraft operations with weight increases in Regulated aircraft weight limitations, equivalent to the non-recognized weight errors currently allowed today.

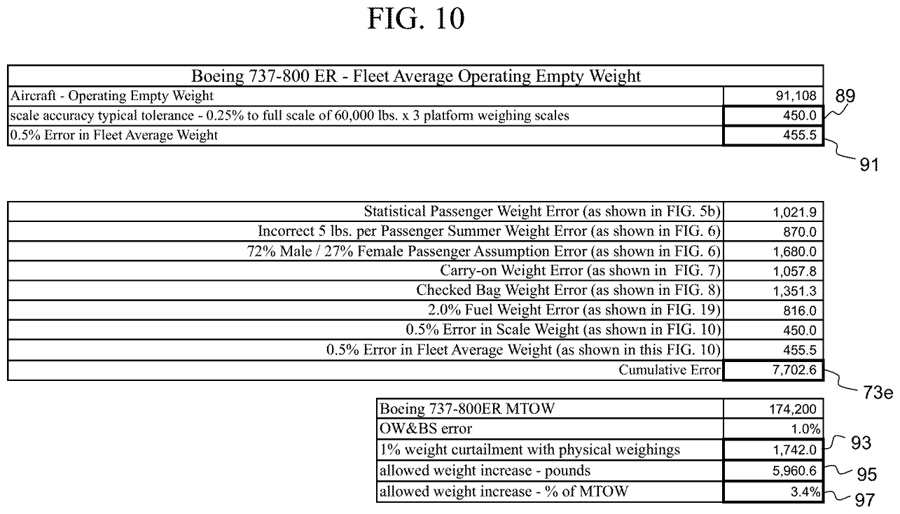

Airlines welcome any opportunity to increase the payload capabilities of their aircraft, considering the opportunity to increase the MTOW and associated MLW and MZFW limitation by up to 5,960 pounds and 3.4% of the MTOW (shown in FIG. 10); through the use the today's aircraft weight measuring systems, to more accurately determine the total aircraft weight.

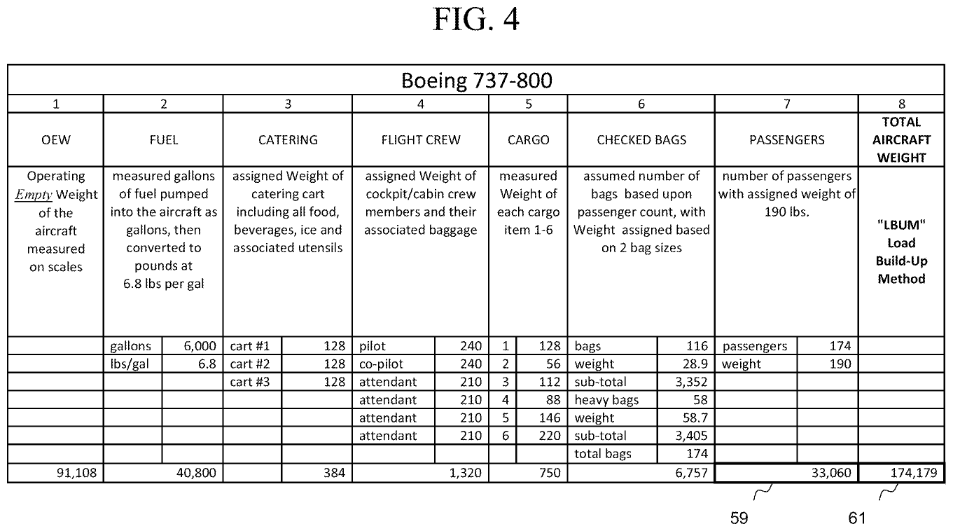

In the preferred embodiment, the method for obtaining a Regulatory Authorities' approval for an increase in the aircraft MTOW and associated MRampW, MLW and MZFW limitations includes the following steps:
1. Record daily determinations of the total “computed” weight of the aircraft using existing weight determination procedures provided in the LBUM process (for example, shown in FIG. 4);
2. Periodically determine the total “measured” weight of the aircraft using an OBWBS (for example, refer to U.S. Pat. No. 5,214,586—Aircraft Weight and Center of Gravity Indicator; or U.S. Pat. No. 5,548,517—Aircraft Weight and Center of Gravity Indicator); or other suitable means to measure aircraft weight and CG;
3. Develop an aircraft “Weight and CG Reliability Program” utilizing the following steps:
   a. Measure the aircraft take-off weight and CG with a periodic weighing frequency acceptable to Regulatory Authorities,
   b. Compare the periodically measured aircraft take-off weight and CG to corresponding LBUM take-off weight and CG computations,
   c. Develop a data-base of identified trends in the differences in weight amounts and differences in CG locations,
   d. Utilize the measured weight and CG data, compared to the LBUM weight and CG data, to establish the amounts for weight adjustments to be incorporated into the airline's LBUM passenger and bag weight assumptions,
      i. The FAA, through AC120-27E guidance, allows for airlines to adjust the weight allocations for passenger and bags; with evidence the revised weights are more accurate.
   e. Over a defined period of time, being acceptable to Regulatory Authorities (i.e.: days, weeks or months), apply the adjustments to passenger and baggage weight assumptions, to improve the LBUM weight and CG determinations, and using the new assumed weight assumptions align the computed aircraft weight with the measured aircraft weight.
      i. Comparison of measured aircraft CG to that of LBUM determined aircraft CG will aid in determining the amount of change designated for the bag weight assumptions, in that individual “assumed bag weights” are tracked in the positioning of those bags within the forward and aft baggage compartments, and non-recognized errors in bag weight will become recognized through monitoring of the aircraft CG.
   f. Upon analysis of measured weight and CG data compared to LBUM weight and CG data, and gaining assurances that the LBUM weight and CG assumptions have been sufficiently modified to reflect what would be an equivalent measured weight and CG; increase the aircraft MTOW, MLW and MZFW limitations in an amount no greater than the total of the illustrated non-recognized weight errors, less an amount equivalent to the accuracy tolerance for the OBWBS used to measure aircraft weight and CC, or other means used to measured aircraft weight.
4. Create a look-up table within the OBWBS computer to compile a data-base of any future amounts of non-recognized weight transported, by continual comparison of measured aircraft weight to LBUM determined weight, to promote assurances that the Regulated aircraft have safely flown and continue to safely fly at weights which have been increased to a higher certified MTOW limitation.

A question still remains; “Why not just used measured aircraft weight and CG for every dispatch?”

As previously mentioned; “As good as an OBWBS might be for measuring the aircraft weight, such a system cannot plan the aircraft load.” Airlines attempt to avoid any situation where a discovered discrepancy in the aircraft weight or CG, identified by use of a measured aircraft weight, might result in a schedule delay. Thus the development of a “Weight and CG Reliability Program” to allow Regulatory Authority's the assurance that the aircraft is being operated as safe as the aircraft has historically been operated while transporting the non-recognized weight errors; and with increase MTOW equivalent to the non-recognized errors historically allowed, will allow for the airline to proportionally increase the weight transportation capabilities of their aircraft.

Regulatory Authorities may choose to limit the amount of MTOW increase, to allow only some smaller percentage of the non-recognized weight errors, with airlines are using the “Weight and CG Reliability Program.” Airlines may consider the additional benefits of having the full percentage of non-recognized weight errors added to the MTOW if they immediately begin using measured weights and CG to dispatch their aircraft, and deal with any potential schedule disruptions if the measured aircraft weight is found greater than the increased MTOW limitation.

Though any of the methods herein described may be used, with potential variations in overall accuracy of the weight determination; the preferred method is to use OBWBS to determine weight supported at each landing gear strut.

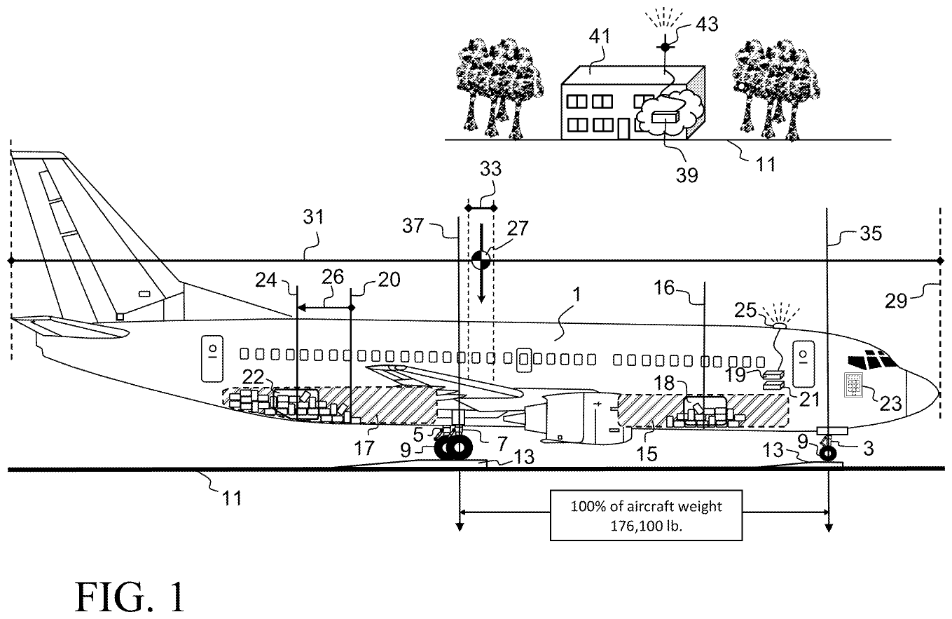

The methods described herein are applicable as procedures and practices used to obtain Regulatory Authority approval to amend existing aircraft weight calculation practices for determining varieties of aircraft weights including: MRampW, MTOW, MLW and MZFW. Referring now to the drawings, wherein like reference numerals designate corresponding parts throughout the several views and more particularly to FIG. 1 there is shown a side view of a typical Boeing 737-800 transport category “Part 25” aircraft 1, supported by tricycle landing gear configuration consisting of a nose landing gear 3, and two identical main landing gears, including a left main landing gear 5 and a right main landing gear 7 (both main landing gear positioned at the same location longitudinally along the aircraft, but shown in perspective view for this illustration).

Landing gears 3, 5 and 7 distribute the weight of aircraft through tires 9, which in this illustration rest atop of a platform weighing scale 13, with platform weighing scale 13 resting on the ground 14. Each of scales 13 measure a portion of aircraft 1 weight, supported at each respective landing gear, and with the three scale 13 weight measurements added together, they identify the total weight of aircraft 1 in this example at 176,100 lbs., being 1,900 lbs. (or 1.09% of MTOW) in excess of the certified MTOW of 174,200 lbs. for this Boeing 737-800 aircraft. Aircraft 1 has a forward baggage compartment 15 and an aft baggage compartment 17.

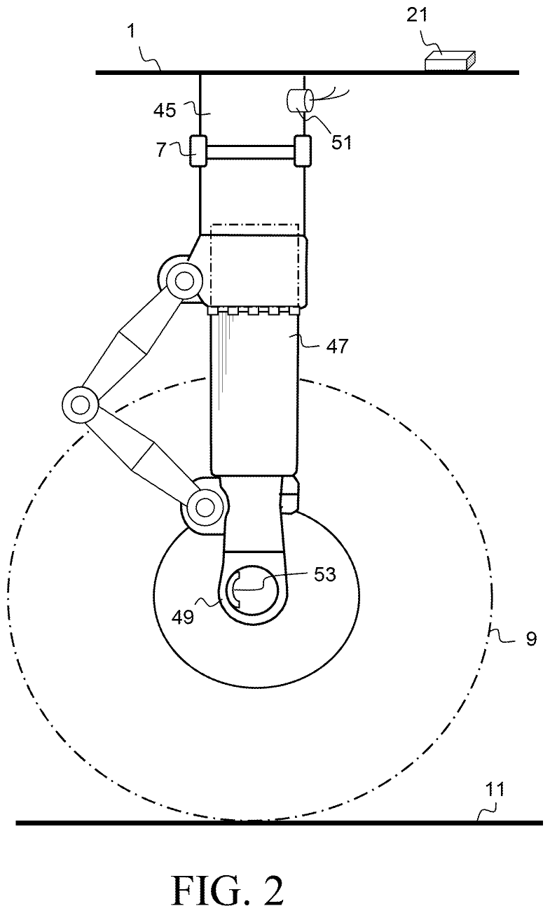

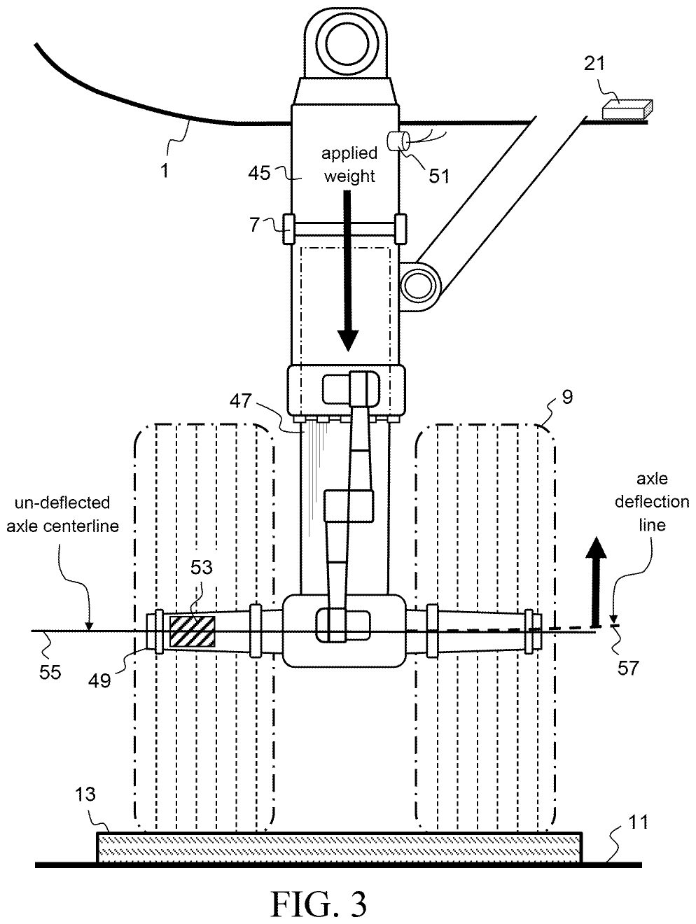

Electronic elements which are used in this invention, and are attached to aircraft 1, are an on-aircraft data acquisition computer 19, aircraft inclinometer 21 to correct measured aircraft angle of inclination to that being level with the horizon, cockpit display/keypad 23 allowing pilots a means to read on-aircraft computer 19 information and allow pilots to input data into on-aircraft computer 19, landing gear strut pressure sensors 51 and landing gear axle deflection strain gauge sensors 53 (shown in FIG. 2 and FIG. 3). On-aircraft computer 19 contains various internal circuit boards for the collection of strut pressure/temperature data and axle deflection data from respective landing gears 3, 5 and 7.

On-aircraft computer 19 is capable of wireless communication with a corresponding off-aircraft computer 39 which is located within a building 41. Off-aircraft computer 39 has no aircraft or landing gear sensor inputs. Off-aircraft computer 39 receives, sensor input data recorded by on-aircraft computer 19 via wireless communications. Regulatory Authority's certification of software is required within any computer permanently attached to the aircraft 1. Use of on-aircraft computer 19 to only measure and record sensor data, and make no sophisticated calculations or computations; to then subsequently and wirelessly transmit only the recorded and date/stamped sensor data to off-aircraft computer 39 which does not reside on aircraft 1, can allow for a significant reduction in the system's software certification costs associated with providing airlines with this information. As an example: aircraft On-Board Weight and Balance Systems (“OBWBS”) require Regulatory Authority certification for any internal software. Ground based computers that determine the same aircraft weight and balance information require far less stringent levels of software certification.

100% of the weight of the aircraft rest upon the combined left and right main landing gears 5, 7 and nose landing gear 3. The aircraft Center of Gravity (“CG”) 27 can be determined by the comparing the measured weight (or if weight measurements are to be avoided, measured load as identified by strut pressure or axle deflection) supported by the combined main landing gears 5, 7 to that of the measured weight supported by the nose landing gear 3. As the percentage of the weight supported by nose landing gear 3 changes in relation to the weight supported by the combined main landing gears 5, 7; so does the location of the aircraft CG 27.

Vertical dotted line 29 illustrates the forward end of aircraft 1. Horizontal line 31 illustrates the length on aircraft 1 being 1,554 inches long.

Downward pointing vertical arrow 35 illustrates the location for weight of aircraft 1, supported by the nose landing gear 3. Downward pointing vertical arrow 37 illustrates the location for weight of aircraft 1, supported by the combined left main 5 and right main 7 landing gears.

The accurate determination of aircraft 1 CG 27 is a critical process in the load planning for aircraft 1. Though aircraft 1 is 1,554 inches in length as shown by horizontal line 31, the forward and aft limit of the operational center-of-gravity envelope is only 42 inches in overall length, as illustrated by horizontal line 33. With just 42-inches of allowable certified center-of-gravity envelope, airline dispatchers must take great care in determining the amount and specific location of weight loaded onto aircraft 1.

Typical LBUM loading computations assume all of the bags are loaded and evenly distributed throughout baggage compartment as shown in forward baggage compartment 15. The assumed even distribution of the bags results in the total assumed weight of bags located at the geographic center of forward baggage compartment 15, shown as vertical line 16. The Boeing 737-800 aircraft forward baggage compartment 15 is twenty-five feet in total length, with the forward compartment door 18 located at the center of the compartment 15. The aft baggage compartment 17 is thirty-six feet in length, with the geographic center of aft compartment 17, shown as vertical line 20. Aft baggage compartment door 22 is located near the rear of the aft compartment 17. In this illustration forward baggage compartment 15 has an even distribution of bags, where the assumed weight is assigned to the location at the center of the compartment, as illustrated by vertical line 16. Aft baggage compartment 17 has the concentration of checked bags located in the aft portion of baggage compartment 17, shown by vertical line 24. The LBUM loading computation will not recognize this difference in the location of weight associated with the aft positioned bags in compartment 17, and its non-recognized shift in aircraft CG 27 further aft, as shown by “aft-shift arrow 26”. Both forward and aft baggage compartment are equipped with restraining nets that hold the bags in place, to avoid the bags sliding as the aircraft 1 takes-off. This non-recognized aft loading of the bags could have the aircraft CG 27 located beyond the aft center-of-gravity limit, creating a scenario where the aircraft is too tail heavy in which the aircraft could over-rotate at take-off, then stall and possibly crash. Measured aircraft CG 27 allows for a Superior Level of Safety, in comparison to the approved methods for determining CG 27 today.

Although the weight of aircraft 1 is shown measured on platform weighing scales 13, the weight of the aircraft can be measured by a variety of OBWBSs (as shown in FIG. 2 and FIG. 3).

Referring now to FIG. 2 which illustrates apparatus for an OBWBS used as a method to measure aircraft 1 weight, where there is shown a side view of a typical aircraft telescopic right main landing gear strut 7, comprising the landing gear strut cylinder 45, in which strut piston 47 moves telescopically within strut cylinder 45. Pressure within landing gear 7 is monitored by a pressure sensor 51. All weight supported by tire 9 is transferred through axle 49, to piston 47; resulting in variations to landing gear strut 7 internal pressure, as recorded by pressure sensor 51. As weight is applied to landing gear strut 7, telescopic piston 47 will recede into strut cylinder 45, reducing the interior volume within landing gear strut 7 and increasing internal pressure in proportion to the amount of additional weight applied. Pressure sensor 51 will measure changes of strut pressure. With corrections made for pressure errors caused by landing gear strut seal friction, landing gear strut 7 functions as an equivalent to aircraft weighing scale 13 (shown in FIG. 1), but; with the capability of folding up and moving with the aircraft 1. As weight is added to landing gear strut 7 axle 49 will deflect in direct proportion to the amount of added weight. Deflection of axle 49 (shown in FIG. 3) is measured by strain gauge sensor 53.

Referring now to FIG. 3 which illustrates an alternate view of the apparatus for an OBWBS used as a method to measure aircraft 1 weight, where there is shown a side view of a typical aircraft telescopic main landing gear strut 7 comprising landing gear strut cylinder 45, in which strut piston 47 moves telescopically within strut cylinder 45. Landing gear strut piston 47 attached to an axle 49 which uses a wheel and tire 9 to transfer aircraft weight to the ground 11. Pressure within landing gear 7 is monitored by a pressure sensor 51. Pressure measured by pressure sensor 51 is proportional to the amount of applied weight onto landing gear 7. The applied weight to landing gear 7 is also measured by axle deflection sensor 53, which is bonded to axle 49. Axle deflection sensor 53 can be of the strain gauge variety, which measures the vertical deflection of axle 49. A bold solid line 55 is shown running horizontal across the center-line of landing gear axle 49 and represents an un-deflected stance of the landing gear axle 49. As additional weight is applied the landing gear strut 7, axle 49 will deflect. A bold dashed-line 57 illustrates a very slight curve; representing vertical deflection from solid line 55 of axle 49 and is shown running adjacent to the un-deflected bold solid line 55. The amount of deflection of landing gear axle 49 is directly proportional to the amount of weight applied. As weight is applied to landing gear strut 7, the increase in weight will be immediately sensed by the additional deflection of axle 49 and measured by strain gauge sensor 53. In this illustration, scale 13 is placed between tires 9 and ground 14. The associated weight of aircraft 1 supported by landing gear strut 7 is measured by scale 13. The weight measurement of scale 13 corresponds directly with the measured deflection of axle 49 by axle deflection sensor 53.

Axle deflection sensor 53 will transmit a signal representing the weight applied to the landing gear strut 7, to the system on-aircraft computer 19 (shown in FIG. 1). As weight is added to landing gear strut 7 axle 49 will deflect in direct proportion to the amount of added weight.

Referring now to FIG. 4 there is shown a chart listing various weight categories for which airlines typically use to determine the total weight of an aircraft before flight. This practice is commonly called the Load Build-Up Method “LBUM”. The aircraft selected for the example is the Boeing 737-800. The example chart in this FIG. 4 is divided into eight columns with each column number 1-8 shown at the top of each column.
Column 1 represents the Operating Empty Weight “OEW” of the aircraft. The OEW is the weight of the empty aircraft. One method to measure the empty weight of the aircraft is to roll the aircraft onto three platform-weighing scales, with one landing gear resting on each of the scales. Each scale measures the weight supported by each respective landing gear and the weights are added together to measure the aircraft total weight (shown in FIG. 1). An alternate method to measure the empty weight of an aircraft is to place it onto tripod floor-jacks, then lift the entire aircraft up and off of the hanger floor. A load-cell is located at the top of each floor-jack; so that once the aircraft is suspended above the floor, the weight of the aircraft rests on the three load-cells (this method is not shown). The OEW is then measured and the aircraft CG is further determined from the measured aircraft weights. Though the term OEW identifies the aircraft as empty, the aircraft is empty of fuel, payload and crew. Other items such as engine and systems hydraulic fluid, in-flight magazines, galley items such as coffee-makers and other lavatory items are considered part of, and are included in the OEW. In this example, the OEW of the Boeing 737-800 aircraft is 91,108 lbs. Aircraft are reweighed on a periodic basis to account for changes in OEW.
Column 2 represents the weight of the fuel which is carried within the aircraft fuel tanks. In the determination of aircraft weight, the fuel weight is determined by recording aircraft fuel indicator readings. Fuel is pumped onto the aircraft through flow-meters which measure the fuel flow in gallons, and the aircraft fuel tank system has an indicator which converts the volume of fuel contained within each tank into a quantity indicated as pounds. The typical conversion rate is 6.8 pounds per gallon of fuel. In this example 6,000 gallons of fuel are contained within the fuel tanks, totaling 40,800 lbs.
Column 3 represents the weight associated with the food, beverages and other catering items planned for consumption during the flight. Airlines typically use catering carts which are pre-loaded with food, beverages and ice, prior to being loaded onto the aircraft. There are several types of catering carts; either a lighter cart filled with trays of food, or a heavier cart filled with canned soda beverages and ice. Each respective cart has a standard weight assigned to it based on the size and capacity of the cart. In this example, three of the heavier 128 lb. beverage carts are loaded onto the aircraft, totaling 384 lbs.
Column 4 represents the weight of the flight crew. The airline flight crew weights are divided into two categories: pilot-crew and cabin-crew. FAA regulations regarding assumed/assigned/designated weight values used in the LBUM are contained within FAA Advisory Circular—AC120-27E. AC120-20E designates a weight for each pilot at 240 lbs. The pilot is assumed to be carrying personal baggage and additional flight charts and aircraft manuals onto the aircraft. FAA regulations require 2 pilots (including a co-pilot) for this FAA Part 25 category of aircraft. FAA Regulations require one flight attendant for each block of 50 passengers, for which the aircraft is certified to carry. AC120-27E designates a weight for each cabin attendants at 210 lb., which includes personal baggage. The Boeing 737-800 aircraft is certified to carry a maximum of 174 passengers, thus the weight of 4 cabin attendants for this size of aircraft is applied. Combined pilot and cabin attendant weights total 1,320 lbs.
Column 5 represents the “measured weight” of the cargo loaded. Each of the 6 respective cargo items for this example flight is pre-weighed on scales prior to being loaded onto the aircraft. The cargo weight for this example flight totals 750 lbs.
Column 6 represents the weight of the checked bags (those bags which are loaded into the baggage compartments located below the aircraft cabin floor). AC120-27E designates weight values for two types of checked bags, depending on the assumed size of each bag. Smaller bag weights are assigned at 28.9 lbs. each. Larger bag weights are assigned at 58.7 lbs. each. For this flight there are 116 small bags totaling 3,352 lbs., plus an additional 58 large bags totaling 3,405 lbs., for a combined checked bag weight total of 6,757 lbs.
Colum 7 represents the weight of 174 passengers for this flight. AC120-27E designates weight values for average passenger weights at 190 lb. for summer weights and 195 lbs. for winter weights. It is assumed that during colder months, passengers will include more clothing as they board the aircraft. The summer average passenger weight of 190 lbs. is used between May 1^{st}-October 31^{st} and winter weight of 195 lbs. is used between: November 1^{st}-April 30^{th}. With this example, the lower 190 lbs. summer weight assumption is being used. The passenger weight includes carry-on items. Such carry-on items include bags, purses, small luggage, backpacks, etc. With all tickets passenger boarding the aircraft, the weight of 174 passengers total 33,060 lbs. (shown in box 59).
Column 8 represents the computed total weight of the aircraft. Summing the totals along the bottom of columns 1-7 equals a 174,179 lbs. determination for the aircraft total weight (shown in box 61). Typical airline operations round-up the weight determination to the nearest 100 lbs. increment. The 174,179 lbs. accumulation is increased to 174,200 lbs. of aircraft total weight as determined by the LBUM; which also happens to be the MTOW limit for this Boeing 737-800 aircraft.
In the United States of America, the FAA is the Regulatory Authority that approves the designated weights. In other countries or regions, other Regulatory Authorities may have jurisdiction.

Referring now to FIG. 5a, there is shown an illustration of a passenger weight build-up chart illustrating the passenger weight distribution for a fully loaded Boeing 737-800 aircraft. The Boeing 737-800 aircraft is a typical narrow-body aircraft. The aircraft cabin is configured to carry a maximum of 174 passengers within a single economy class cabin having 6-across seating shown as seats in columns A, B, C, D, E and F. There are 29 equally spaced rows; shown vertically on the left side of the chart identified as Aircraft Row # 1-29.

Regulatory Authority guidance found in AC120-27E shows the average passenger weight has been established from the National Health and Nutrition Examination Survey (NHANES) conducted by the Centers for Disease Control (CDC) in 1999. The NHANES data conducted actual scale weighings of approximately 9,000 subjects. The standard deviation for NHANES survey was 47 lbs. (this value will be used again to generate thousands of randomly selected passenger weights). The NHANES survey data concluded the population with a “mean” average weight for males as 184 lbs. plus 16 lbs. of additional weight was added for carry-on items totaling 200 lbs. The average weight for females was determined at 163 lbs. plus 16 lbs. of additional weight was added for carry-on items.

In this example illustrates a full flight, where all available seats have been allocated to passengers with an AC120-27E designated average passenger weight of 190 pounds per person, including carry-on baggage. The 190 lbs. passenger weight assumes 50% of the passengers are male and 50% of the passengers are female. The computation for the total passenger weight is the simple equation of 190 lbs.×174=33,060.00 lbs. (shown in box 59).

Referring now to FIG. 5b, there is shown an alternate illustration of the passenger weight build-up chart of FIG. 5a; but instead of 190 lbs. being assigned to each seat; randomly generated passenger weights are assigned to each of the 174 seats. The random generation of 174 simulated passenger weights can been established from a pool of 256,000 randomly generated passenger weights through the “Random Number Generation Tool” within the Analysis Tool Pack of the Microsoft Office Excel program; where 190 pounds was chosen as the “Mean” (representing average weight), and 47 (representing pounds) was designated as the “Standard Deviation” and 265,000 random numbers (the maximum number allowed in the Excel program) are requested. From the 265,000 randomly generated numbers, the initial block of numbers containing the first 174 values was selected and assigned to the 174 seats of the Boeing 737-800 used in the chart model for this example. The total passenger weight value from the random passenger weight totaled 34,081.93 (shown in box 65). Analysis of the 174 random passenger weights found in this initial block of random weights, the average weight was 195.87 lbs. (shown in box 63). Multiplying the additional 5.87 lbs. weight error times the 174 filled seats, finds a total non-recognized weight error of 1,021.93 lbs. (shown in box 67).

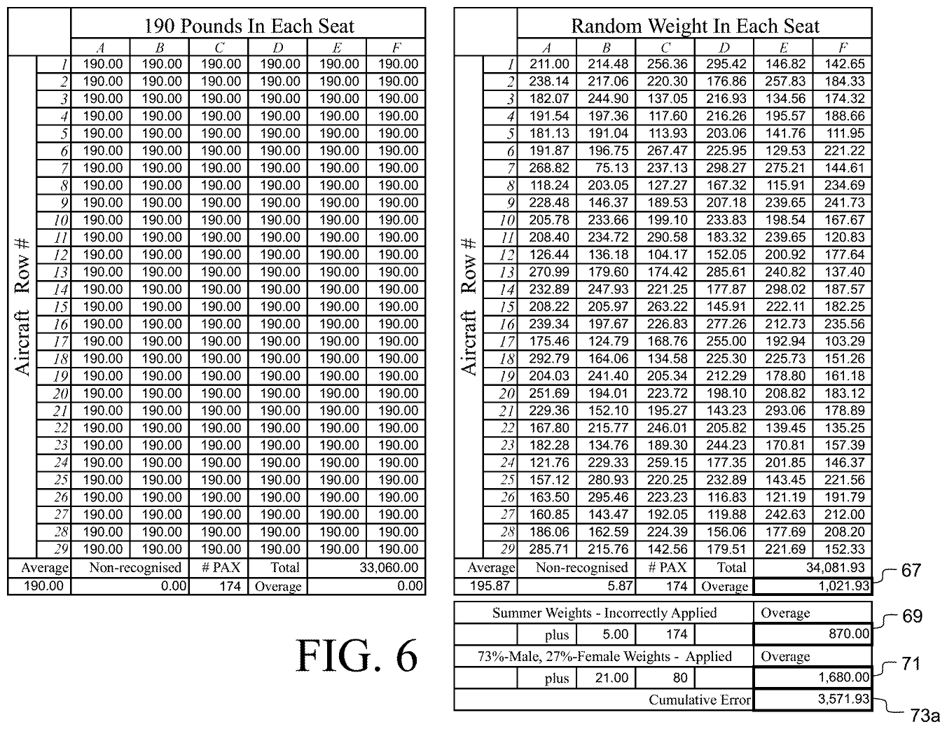

Referring now to FIG. 6 there is again shown the non-recognized weight error of 1,021.93 lbs. associated with random passenger weights, (shown in box 67). An additional non-recognized error of 870.00 lbs. (shown in box 69) takes into account an additional 5 lbs. of winter clothing weight for the passengers on an October 15^{th}, 6:00 am departure from an airport in Chicago, Ill.; with a morning temperature of 36° where AC120-27E assumes since the November 1^{st} calendar date has yet to arrive all of the 174 passengers are still wearing summer clothing. The Regulatory Authorities will assign the additional 5 lbs. per person for winter clothing weight, but only 2 weeks later than this flight departed, with the substantial weight error.

Regulatory Authorities make another assumption that within each of the 28,537 daily departures, the passenger distribution between male/female will always be 50% male and 50% female. If the distribution varies whereby 73% of the passengers are male and an additional 40 male passengers are 21 lbs. heavier along with the corresponding reduction of 40 female passengers which are 21 lbs. lighter; the non-recognized weight error will increase by an additional 1,680 lbs. (shown in box 71).

Beginning with this FIG. 6 and continuing through FIG. 10 there will be shown a variation of “box 73a through 73e” illustrating the cumulative effects of the non-recognized errors applied as the weight of the aircraft increases.

Box 73a illustrates the cumulative non-recognized weight error totaling 3,571.93 lbs.

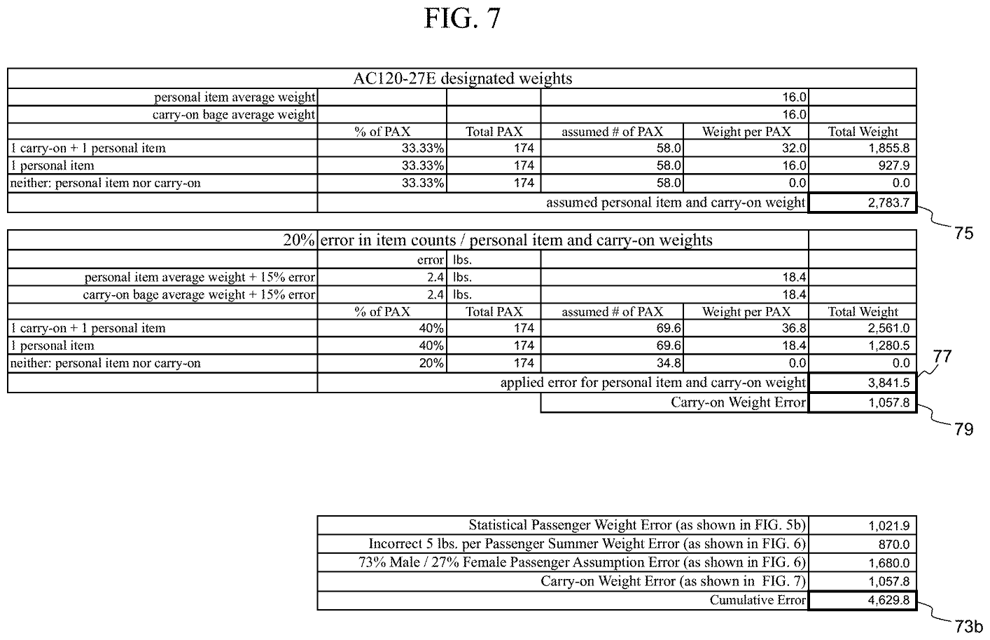

Referring now to FIG. 7, where in 1999 the NHANES conducted weight surveys, supporting AC120-27E being the Regulatory guidance for passenger and baggage weight allocations in loading aircraft. Since 1999 there have been significant advancement in designs for roll-aboard hand-luggage which are now specifically designed to fit snuggly inside the over-head storage compartments within the passenger cabin, and are commonly used as carry-on items and not recognized as luggage. These roll-aboard bags, which are simply a slightly smaller version of typical checked baggage, allow many passengers the convenience of not having to wait for off-loaded checked-bags at the baggage claim departments. These recent trends are allowing more non-recognized weight to be transported within the passenger cabin of the aircraft. Recent airline practices of charging for checked bags have shifted more weight into the “free of charge” carry-on bags, which passengers will pack heavier and carry into the passenger compartment. New designs for the roll-aboard luggage have typical internal dimensions of 22″×15″×9″ allowing 1.72 cubic feet of volume within each bag. An independent test was performed employing ten separate attempts to pack assorted clothing items into the 1.72 cubic feet of the roll-aboard bag, to find variations in the measured bag weights which ranged from a low of 15.6 lbs to a high of 24.7 lbs. The high weight error found in the tests deviated 54.38% above the mean carry-on bag weight of 16 lbs.

This FIG. 7 illustrates the Regulatory Authorities' prescribed weight of 16 lbs. for personal items and carry-on baggage, applied with AC120-27E assumptions of: ^{1/}_{4,} ⅓, ⅓ split for passengers carrying 0, 1, or 2 items. The determined weight for carry-on items totals 2,783.7 lbs. (shown in box 75).

A further comparison was made to today's more typical aircraft boardings with only 20% of the passengers boarding the aircraft with their hands empty, and 40% boarding while carrying only one item, plus an assumed 15% deviation applied to the FAA identified 16 lbs. weight allocation for the carry-on items. The conclusions found in this illustration a potential carry-on weight up to 3,841.7 lbs. (shown in box 77). A comparison of the carry-on bag weight assumption in box 75 to the potential carry-on weight value in box 77 illustrates an additional 1,058.0 lbs. for non-recognized weight error (shown in box 79).

Box 73b illustrates the cumulative non-recognized weight error increasing to 4,629.8 lbs.

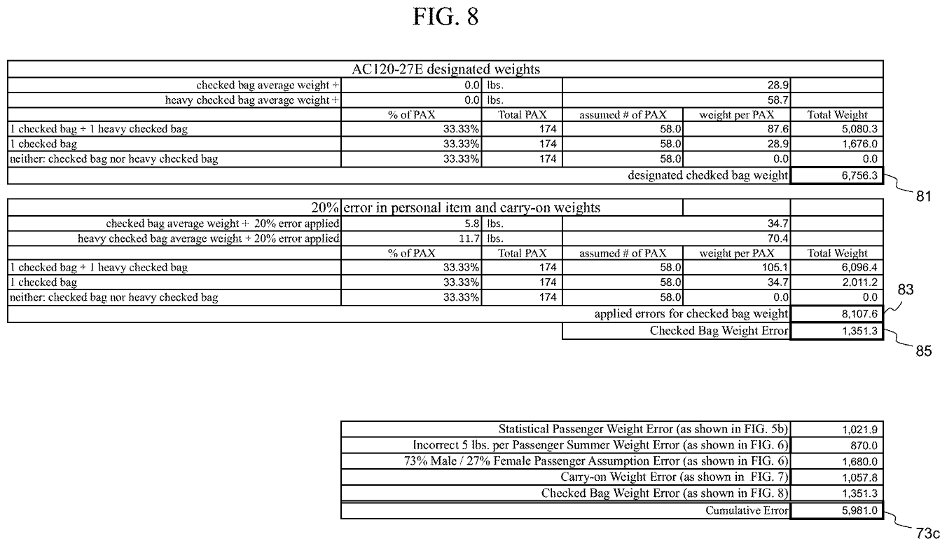

Referring now to FIG. 8 there is shown a comparison of the of the Regulatory Authorities' checked baggage weight designations for both standard bag weight and heavy bag weight for the fully loaded, 174 passenger Boeing 737-800 flight. Checked baggage distribution is applied according to the guidance of Regulatory Authorities' AC120-27E and applied with the following per passenger assumptions: 33%—zero bags, 33%—one checked bag, and 33% one checked bag and one heavy checked bag totaling 6,756.3 lbs. (shown in box 81) compared to the same per passenger bag allocation. Data obtained from a large domestic airline operating a fleet of Boeing 737 aircraft finds passengers checking 1.2 bags per person, compared to the FAA assumed 174 bags for 174 passengers. With this applied 20% increase in number of checked bags, the application of the 20% bag weight error increased the checked baggage total weight by 1,351.3 lbs. (shown in box 85) to a total checked baggage weight of 8,107.6 lbs. (shown in box 83).

Box 73c illustrates the cumulative non-recognized weight error increasing to 5,981.0 lbs.

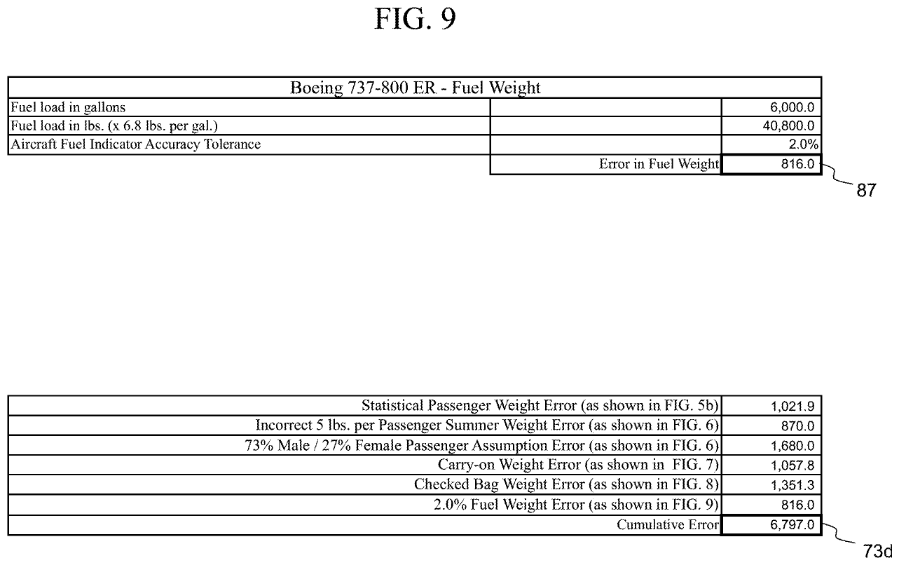

Referring now to FIG. 9 there is shown a calculation for the weight of the fuel required for the planned flight. The Boeing 737-800 used in the example has fuel capacity of 6,875 gallons. Typical aircraft fuel indicators measure the volume of fuel pumped into the fuel tanks with flow-meters, then use 6.8 lbs. per gallon as the conversion rate for the final weight determination. A measure volume within a gallon of jet-fuel will change with changes in temperature. On a warm day, a gallon of fuel will expand thus the gallon will weigh less than a gallon of fuel which has contracted on a cold day. Typical aircraft fuel indicators have an accuracy tolerance of ±2.0%. Though the fuel indicators are not required to have zero error, the Regulatory Authorities allow the fuel indicator weight determinations to be used without any requirement for the consideration of possible errors in the fuel weight. For this example 6,000 pounds of fuel was required for the planned flight. The conversion to pounds determined 40,800 lbs. of fuel. Applying the potential of a 2.0% fuel indicator error, the non-recognized weight error for the fuel is 816.0 lbs. (shown in box 87).

Box 73d illustrates the cumulative non-recognized weight error increasing to 6,797.0 lbs.

Referring now to FIG. 10 there is shown a chart illustrating the non-recognized weight error associated with the weighing of the empty aircraft. AC120-27E provides the Regulatory Authority guidance for use of scales when weighing the empty aircraft, but makes no specific requirements for scales accuracy.
b. An operator should establish and follow instructions for weighing the aircraft that are consistent with the recommendations of the aircraft manufacturer and scale manufacturer. The operator should insure that all scales are certified by the manufacturer or a certified laboratory, such as a civil department of weights and measures, of the operator may calibrate the scale under an approved calibration program.

Scale accuracy typically range with a 0.25% error in the amount of the full weight capability of the scale. Typical platform weighing scales have a maximum weight limitation of 60,000 lbs., thus a 0.25% error would tolerate up to 150 lbs. of error for each scale. While weighing an aircraft, the aircraft must be supported by at least three points. Multiplying by three the 150 lbs. scale tolerances illustrates the 450 lbs. error (shown in box 89).

Regulatory Authorities allow airlines with large fleets of common aircraft types to avoid having to weigh every aircraft in their fleet on the required 3-year intervals. A large domestic air carrier operates a single fleet type of totaling 450 of the Boeing 737-700 aircraft. AC102-27E prescribes the minimum number of aircraft whose weight shall be measured in determining the “average aircraft fleet weight” is defined as a minimum of 6 aircraft, plus 10% of the remaining fleet. The equation for this numbers is: 6+[(450−6)×10%]=50.4 which is rounded up to 51 aircraft. A rotation of 51 separate aircraft, within the common fleet type, must be re-weighed within 3-year intervals. AC120-27E also requires that no aircraft within the fleet shall be allowed to operate with an OEW which is heavier than 0.5% of the fleet average weight. AC120-27E allocated no weight error in OEW for aircraft contained within an average fleet weighing program. The additional non-recognized 0.5% weight error applied to the Boeing 737-800 OEW of 91,108 lbs. is 455.5 lbs. (shown in box 91).

Box 73e illustrates the cumulative non-recognized weight error increasing to 7,364.9 lbs.

In creating a justification basis for Regulatory Authority allowance for the non-recognized weight errors to be allowed as additional weight to the MRampW, MTOW, MLW and MZFW; the Regulatory Authorities must be assured that no other weight errors be allowed in the process for determining aircraft weight. Use of an aircraft weight measuring devise, whether it be ground scales with a typical error of 0.25% or a system permanently attached to the aircraft with typical errors no more than 1.0%; can assure Regulatory Authorities that the non-recognized weight errors can be reduced to errors no larger than those errors in the devices which physically measure the fully loaded aircraft total weight.

The subtraction of the 1,742.0 lbs. (shown in box 93) being the 1.0% error associated with the aircraft weighing device, measuring up to the 174,200 lbs. MTOW limitation of the Boeing 737-800 aircraft, from the total non-recognized weight errors of 7,364.9 lbs. (shown in box 73e) equates to a potential weight increase of 5,622.9 lbs. (shown in box 95) to the MTOW. 5,622.9 lbs. divided as a percentage of the 174,200 lbs. total aircraft weight equates into a 3.2% increase in the MTOW for the Boeing 737-800. The use of an aircraft weight measuring device to eliminate any non-recognized weight errors in excess of weight error associated with the aircraft weight measuring device creates a justification basis for an Equivalent Level of Safety for a Regulatory Authority to allow a MTOW increased weight equivalent to the net difference between the non-recognized weight errors, and the aircraft weight measuring devices error tolerances.

Today's modern aircraft are developed through “generational design criteria.” Different eras of generational aircraft began with the cloth fabric covered bi-wing design of the Wright brothers first aircraft. A subsequent generational design began with use of aluminum structural components and a single wing and rear stabilizer. A later generational design came with the jet engine; followed by today's modern aircraft having jet engines with swept-wings, allowing for greater speeds, thus carrying more weight. More simply said, an aircraft of a specific generation is often scalable. Scalable to the point the aircraft design can be expanded and enlarged by keeping all the generational design features “proportionally aligned.” This allows for a shorter period for design build-up, in the development and certification of a new aircraft, with either smaller or larger sizing percentages.

This also transitions to the weight limitations for aircraft within a specific generational design, being similar. As an example: the Maximum Take-Off Weight “MTOW” (being 100%), with maximum landing weight (being 82% of MTOW), and empty operating weight (being 52% of MTOW). Thus, the appeal for identifying the amount for non-recognized weight errors for a particular aircraft model (with the example shown herein a Boeing 373-800) as a percentage of the MTOW.

When comparing the value for each of the different weight limitations associated with: MTOW, MLW, MZFW; the amount of non-recognized weight errors is a fixed amount; thus, when the OBWBS demonstrated accuracy (in this example 1% of MTOW) is subtracted from the value associated with the non-recognized weight errors, and compared as a percentage of the MTOW (described above as 3.2%) will be a different percentage when compared to MLW (3.8%) and MZFW (4.1%) and shown below:

Boeing 737-800

| | | | |
|---|---|---|---|
| Non-recognized weight errors | 7,364.9 | 4.2% | MTOW |
| OBWBS demonstrated accuracy | −1,742.0 | 1.0% | MTOW |
| Recoverable weight - fixed amount | 5,622.9 | 3.2% | MTOW |
| Maximum Take-Off Weight | 174,200.0 | 3.2% | MTOW |
| Maximum Landing Weight | 146,300.0 | 3.8% | MLW |
| Maximum Zero Fuel Weight | 138,300.0 | 4.1% | MZFW |

The percentage values for recoverable weight, illustrated in this example may change slightly, due to variations in the demonstrated accuracy of a particular OBWBS, and/or the non-recognized weight errors may be found different than those shown in the initial statistical modeling. An example of a significant change in the non-recognized weight errors occurred during the period just prior to Jun. 12, 2021; when airlines were using the old FAA AC120-27E established average passenger weight of 195 pounds. A deadline of Jun. 12, 2021; was established for airlines to complete surveys and implement their revised average passenger weights, which found the average passenger weight at 208 pounds. Multiplying the additional 13 pounds by the 174 passengers on the Boeing 737-800, would have the non-recognized weight errors increasing by an additional 2,262 pounds, beyond the 7,364.9 pounds shown above.

The FAA has established guidelines related to aircraft Onboard Weight and Balance Systems (“OBWBS) and methods for determining accuracy with the issuance of another Advisory Circular—AC No: 20-161, dated Apr. 11, 2008 “Aircraft Onboard Weight and Balance Systems” in which an airline is allowed to use an approved “OBWBS” with demonstrated accuracy within the four (4) acceptable methods to identify accuracy tolerance levels defined within AC20-161. Though the FAA does not specify any precise percentage (“%”) as an accuracy requirement, the 4 methods contained within AC20-161 (briefly described below) can be quickly summarized as:
a. Takeoff Performance Based Method—computations from V₁ and V₂ speed analysis of the Boeing 737-800 aircraft find the accuracy tolerance of ±2%, resulting with the OBWBS's required accuracy at 98%.
b. Specific Operations Method.—Most airlines will not select this method to demonstrate OBWBS accuracy because it creates the most restrictive curtailments of the aircraft's operational envelope' thus the level of OBWBS demonstrated accuracy would need to be 100%, or airlines would be required to curtail or reduce the aircraft manufacture's original weight limitations for the aircraft.
c. Weight and Balance Procedures Method (Load Buildup Method). Though this method, approved in 2008 as an acceptable method for demonstrating OBWBS accuracy; airlines will hesitate in selecting this method to demonstrate OBWBS accuracy, when considering the non-recognized weight errors identified within U.S. Pat. No. 10,089,634 issued Oct. 2, 2018; some 10 years after the establishment of AC20-161 and based upon the statistical and non-recognized weight errors found in current Load buildup Methods, which within this method are only compared against the assumed high accuracy of the Load Buildup Method, which illustrate above can have errors in excess of 4%, resulting with OBWBS's required accuracy at 96%.
d. OBWBS Operational Demonstration Method. Most airlines will select this method to demonstrate OBWBS accuracy, based upon the statistical and non-recognized weight errors found in current Load buildup Methods, which are compared against the OBWBS and further compared against accurate aircraft weighing scales, thus providing the largest potential amount of allowable error for the OBWBS's accuracy demonstration.
   FAA Advisory Circular AC20-161: (accuracy determinations, in full detail)

### 2-3. OBWBS Accuracy Determination Methods.

a. Takeoff Performance Based Method.
(1) This method examines the influence of OBWBS system and operational weight and balance accuracies on aircraft takeoff performance. OBWBS operational accuracies that result in at most a ±1.5 knot error change in either V₁ or V₂ speed, or a 100 foot increase in takeoff or accelerate-stop distance, whichever is greater, are accepted without weight curtailments for OBWBS operational accuracy. OBWBS operational accuracies that result in greater errors than these require appropriate curtailment.
(2) From the minimum value of V₁ to the maximum value of V₂ speed, determine the size of the weight error that results in at most a ±1.5 knot change in V₁ or V₂ speed, or a 100 foot increase in the takeoff or accelerate-stop distances, whichever is greater, for the full range of takeoff weights.
(3) These errors may be used to determine a corresponding operational weight accuracy for a given takeoff weight. This operational weight accuracy is used to determine CG accuracy.
(4) The operational accuracies derived from the impact on takeoff performance help determine the range of the allowable operational and environmental conditions for the OBWBS without curtailment for OBWBS operational accuracies. For example, assume the OBWBS operational accuracy results in at most a ±1.5 knot change in V₁ or V₂ speed, or a 100 foot increase in the takeoff or accelerate-stop distances, whichever is greater, over a specific range of wind gust or wind velocities for a given temperature day and given takeoff weight. The AFM/AFMS limitations section for a given temperature day may then list this wind gust range as a limitation on the use of the OBWBS results without curtailment for operational accuracy.
(5) The AFM/AFMS calls out operational accuracies as a function of the range of the operational and environmental conditions (see paragraph 2-9 of this AC). The OBWBS weight and balance results may be used for takeoff without curtailment for operational accuracy only when the takeoff speed accuracy constraints specified in paragraph 2-3.a(1) of this AC are met and the OBWBS measured CG position±the CG position operational accuracy remains within the takeoff limits of the CG envelope.
   The OBWBS measured weight±weight operational accuracy results in no more than a±1.5 knot change in V₁ or V₂ speed, or a 100 foot increase in the takeoff or accelerate—stop distances, whichever is greater, and
   The OBWBS measured CG position±CG position operational accuracy remains within the takeoff limits of the CG envelope.
(6) If the cumulative OBWBS operational accuracy does not meet the criteria of paragraph 2-3.a(5) of this AC, the OBWBS results must be curtailed for operational accuracy before using them for takeoff
(7) The operator should use an actual takeoff weight corresponding to the measured weight plus weight operational accuracy, and the most adverse CG position corresponding to the measured CG position plus or minus the operational CG accuracy. The operator may need to remove or shift payload to keep these values within the weight and balance envelope. See appendix 4 of this AC for an example of this method applied to a B767-300ER.
   b. Specific Operations Method.

This method uses OBWBS weight and balance measurements taken while the aircraft is subjected to a pre-defined range of environmental disturbances in order to establish operational accuracy and procedural adjustments (i.e., weight and/or CG envelope curtailments). Operational accuracy levels, expressed as maximum weight, and CG errors experienced are then applied as curtailments to the original manufacturer's envelope, as published in the type certificate data sheet, AFM/AFMS, or weight and balance manual. This method offers the smallest hurdle to determination of an envelope for OBWBS operation, but will typically result in the largest curtailments when compared to the other methods offered.
(1) To demonstrate the OBWBS operational accuracy, you should:
   Establish the proposed range of operational and environmental conditions in which the OBWBS will operate. These conditions determine the content of the limitations and conditions as described in paragraph 2-9 of this AC.
   Ground test the OBWBS under each of the conditions identified in the limitations and conditions as described in paragraph 2-9.a of this AC. You can use analysis as an alternative to testing if you can substantiate the analysis approach.
   For example, suppose the aircraft manufacturer provides environmental or operational limitations, or procedures, that ensure the airplane always operates within the certified weight and CG envelope. Your OBWBS installation may operate within those same restrictions without demonstration.
(2) Use the OBWBS operational accuracy to identify all operational limitations (such as weight and/or CG envelope curtailments when operating at specific points in the range of limitation values) determined through this process in the AFM/AFMS.
   c. Weight and Balance Procedures Method (Load Buildup Method).

The OBWBS operational accuracy may be compared to existing OEM and FAA recommended procedures for computing weight and balance values for a given aircraft configuration. These procedures, also known as load buildup methods, have acceptable accuracies as proven in past service experience. The load buildup method weight and CG accuracies as derived from analysis of these procedures help determine the range of the allowable operational and environmental conditions for the OBWBS without curtailment for OBWBS operational accuracies. The curtailed envelope applicable when using the load buildup method also applies to the OBWBS weight and CG measurements as long as OBWBS operational accuracy remains equal to or better than the accuracy determined for the load buildup method. Curtail the limits of the CG envelope for any OBWBS operational accuracy that is worse than the accuracy of the load buildup method.
(1) Assess the load buildup method's operational accuracy by considering a variety of factors recommended by the aircraft manufacturer and AC 120-27E, Aircraft Weight and Balance Control, as guidance material. See FIG. 1 in this AC.

### FIG. 1. FACTORS TO CONSIDER FOR LOAD BUILDUP METHOD.

| | Effect on | Effect on |
|---|---|---|
| Factor | Weight | CG |
| Scale accuracy during reweigh | X | X |
| Fuel quantity indicating accuracy | X | X |
| Allowable weight/CG variation prior to | X | X |
| “reestablishment” of operational empty weight (or | | |
| allowance for potential variation due to use of | | |
| fleet weights) | | |
| Variation in catering/provisioning | X | X |
| Variation in male/female ratio | X | X |
| Passenger weight variation | X | X |
| Crew weight variation | X | X |
| Baggage weight variation | X | X |
| Cargo weight variation | X | X |

(2) Tolerable errors associated with each factor are as follows:
   (a) Scale accuracy for reweigh—Typically 0.2% of basic empty weight (BEW), based upon reported scale accuracy for analog scale systems or 0.1% of BEW for digital scale systems. Analog accuracy value may be used for aircraft for which the aircraft OEM guidance does not recommend or require the use of digital scales.
   (b) Fuel quantity indicating accuracy—Typically 3% of full capacity.
      See:
      SAE AS-405C, Fuel and Oil Quantity Instruments, dated July 2001, or the most current revision;
      Military document MIL-G-8798, General Specifications for Fuel-Quantity, Capacitor-Type Gage System, dated Sep. 30, 1992, or the most current revision, or
      MIL-G-26988C, General Specification for Liquid Quantity Gage, dated Sep. 28, 1995, or the most current revision.
   (c) Operational Empty Weight Variation—½ of one percent of the mean aerodynamic chord (MAC) and ½ of one percent of maximum landing weight, as outlined in AC 120-27E.
   (d) Variation in catering/provisioning—Amount of variation that could be expected to exist, undetected, in galley provisioning. Typically, 20% of the standard galley stock or galley cart weights.
   (e) Variation in male/female ratio—Amount of variation in ratio of male to female passengers permitted without adjusting passenger weights in use, typically 10% deviation from ratio upon which passenger weights were based, as outlined in AC 120-27E.
   (f) Passenger weight variation—Typically a 1% variation in passenger weight plus a 2% variation in carry-on baggage and personal item weights, defined as tolerable error by AC 120-27E.
   (g) Crew weight variation—Typically a 25% variation in the standard crewmember weights, or that amount found to be justified based upon sampling or survey of crewmember weights.
   (h) Baggage weight variation—Typically a 2% variation in baggage weight (including both checked and designed heavy weight bags), as defined as tolerable error by AC 120-27E.
   (i) Cargo weight variation—Typically a 1% variation in actual cargo weight verses reported cargo weight, based upon typical scale accuracy.
(3) The items eligible for consideration do not include those which originate from human error factors, such as baggage miscount, incorrect passenger count, omitted cargo weights or omitted jump seat occupants. The cumulative accuracy of the load buildup method may be calculated by taking the square root of the sum of the squares of the factor accuracies (addition in quadrature), or demonstrate through analysis or test. You choose which of these methods to employ.
(4) In demonstrating the OBWBS operational accuracy, you should:
   Establish the proposed range of operational and environmental conditions in which the OBWBS will operate. These conditions determine the content of the limitations and conditions as described in paragraph 2-9.a of this AC.
   Ground test the OBWBS under each of the conditions identified in the limitations and conditions as described in paragraph 2-9.a of this AC.
   Use the OBWBS operational accuracy to identify any operational limitations (such as weight and/or CG envelope curtailments when operating at specific points in the range of limitation values) determined through this process in the AFM or AFMS.
      d. OBWBS Operational Demonstration Method.

This method may be used to evaluate OBWBS operational accuracy during revenue service for a trial period, or in non-revenue operation as part of a planned ground test program.
(1) Continue to use the original weight and balance program, as applicable, during the demonstrations with the OBWBS installed for evaluation purposes only.
(2) During a trial period in revenue service, the current load buildup system is used as the primary means of performing the weight and balance functions for the airplane and records all OBWBS measurements.
(3) Ground tests can demonstrate equivalent safety between an OBWBS implementation and the current load buildup system by comparing to precision aircraft scale weighing. Note that differences between the scale and load buildup CG's may exist that would not be considered as part of the load buildup CG error. These differences include load buildup curtailments as described in AC 120-27E, Aircraft Weight and Balance Control, as well as differences in the weights being compared (for example, taxi weight vs. takeoff weight).
(4) In determining the OBWBS operational accuracy, use the OBWBS system accuracy that is at least as accurate as, or better than, the current load buildup system
(5) The limits of the OBWBS weight and CG envelope must be curtailed for any OBWBS operational accuracy that exceeds the accuracy of the load buildup method.
(6) Design the demonstration plan to allow multiple tests at multiple airplane weight and CG configurations. Include sufficient trials in the demonstration plan to show to a confidence interval of at least 95% that the statistics of the OBWBS weight and balance measurements are at least as accurate as the original program being used. Conduct a minimum of twenty five weighing trials.
(7) At least 30% of the tests should be at weights within 10% of maximum airplane takeoff weight; at least 10% of the tests should be at weights within 10% of the minimum airplane takeoff weight; and the tests should cover the aircraft weight and CG envelopes.
(8) Also, test applicable environmental considerations throughout the operating envelope. During a revenue service demonstration, the actual airplane weight can be obtained with a precision scale weighing of the loaded airplane prior to departure.

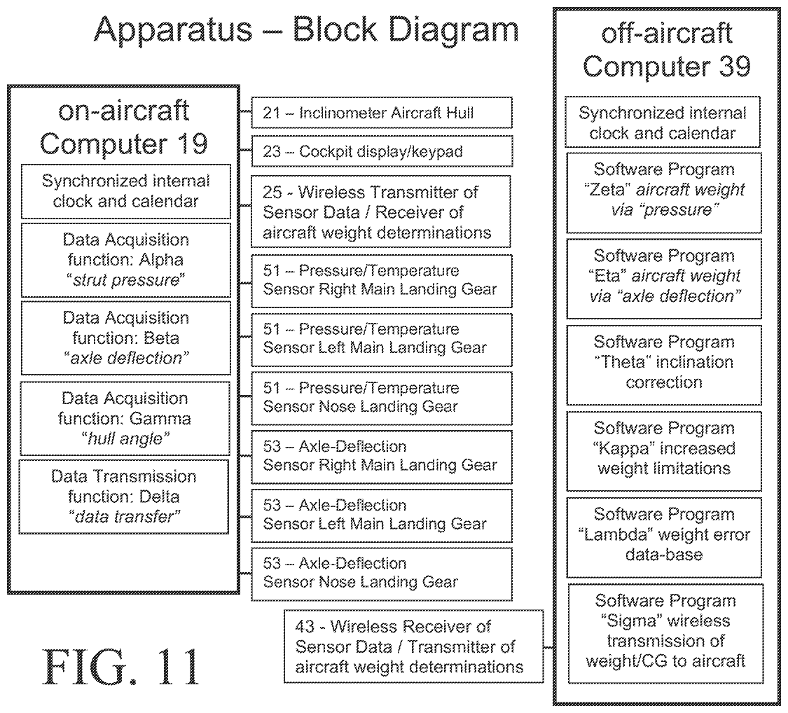

Referring now to FIG. 11 there is shown a block diagram illustrating both the on-aircraft computer 19, with various sensor inputs and the off-aircraft computer 39 with various Software Programs; being part of the apparatus of the invention. Sensor inputs to on-aircraft computer 19 include multiple inputs from (respective nose 3, left-main 5 and right-main 7 landing gear) strut pressure sensors. Strut pressure sensor 51 incorporates a temperature sensor for monitoring internal temperature within the landing gear strut. Sensor inputs to on-aircraft computer 19 also include multiple inputs from (respective nose 3, left-main 5 and right-main 7 landing gear) landing gear axle deflection measuring sensors 53. Aircraft hull inclinometer 21, is located on any horizontal portion of the aircraft 1, and also has an input to on-aircraft computer 19. On-aircraft computer 19 has a cockpit display and keypad 23, which allows pilots to discern information from and input data to on-aircraft computer 19. The on-aircraft computer 19 outputs of data and information are transmitted via a wireless transmitter/receiver 25, to a wireless transmitter/receiver 43 attached to off-aircraft computer 39. Various changes of aircraft hull angle, measured by inclinometer 21 are inputs to on-aircraft computer 19.

Both on-aircraft computer 19 and off-aircraft computer 39 are equipped with internal synchronized clocks and calendars, to document the time and date of recorded and received sensor data.

On-aircraft computer 19 has multiple data acquisition/transmission functions which include:
Data Acquisition function “Alpha” which monitors nose and main landing gear internal strut pressure and temperature; and stores the recorded with time and date references to respective strut pressure and temperature measurements to such time as the data is transmitted to off-aircraft computer 39.
Data Acquisition function “Beta” which monitors nose and main landing gear axle deflections; and stores the recorded data with time and date references to respective axle deflection measurements to such time as the data is transmitted to off-aircraft computer 39.
Data Acquisition function “Gamma” which monitors changes the angle of aircraft hull in relation to the level and horizontal ground; and stores the recorded data with time and date references to hull angle change measurements to such time as the data is transmitted to off-aircraft computer 39.
Data Transmission function “Delta” which wirelessly transmits the time and date referenced landing gear sensor data and aircraft hull angle data to off-aircraft computer 39.

On-aircraft computer 19 is limited to landing gear sensor data acquisitions functions and the transmission of that landing gear load data to off-aircraft computer 39. On-aircraft computer 19 is restricted having operating software which calculates the aircraft weight and CG. Having the sophisticated software to make the calculations for “flight critical information” such as aircraft Weight and CG; operating solely within off-aircraft computer 39, substantially reduces the costs for certifying any subordinate software used in the acquisition of landing gear sensor data, residing within on-aircraft computer 19.

Off-aircraft computer 39 has capabilities for wireless reception and transmission of multiple landing gear and aircraft hull angle sensor data records and Software packages and data acquisition/transmission functions which include:
Software Program “Zeta” which processes recorded pressure and temperature sensor data from the respective nose and main landing gear to resolve into values equivalent to the weight supported at each respective landing gear,
Software Program “Eta” which processes recorded axle deflection sensor data from the respective nose and main landing gear to resolve into values equivalent to the weight supported at each respective landing gear,
Software Program “Theta” which processes recorded aircraft hull inclination sensor data from the on-aircraft inclinometer to resolve into a value of off-set equivalent to the aircraft being horizontal,
Software Program “Kappa” which re-processes respective landing gear weight values to determine the total aircraft weight and the aircraft CG as compared to weight and CG limitation thresholds. If a weight and or CG threshold is exceeded, notification of such exceedance will be given.
Software Program “Lambda” which receives manual inputs regarding respective LBUM weight and CG determinations to be compared to as Software program “Kappa” weight and CG determinations to develop a data-base to compute the amounts of non-recognized weight errors historically allowed to be transported on the aircraft,
Data Transmission function “Sigma” which wirelessly transmits back to on-aircraft computer 19 the time and date referenced aircraft weight and CG determinations corresponding to the landing gear sensor data processed.

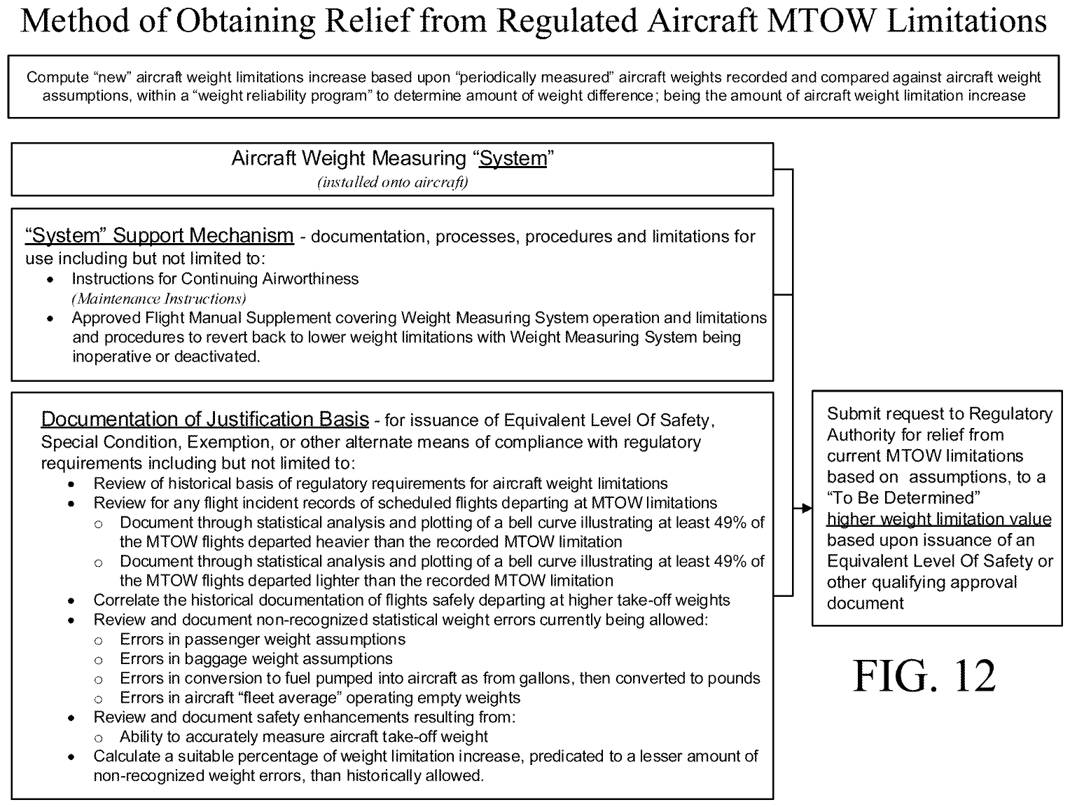

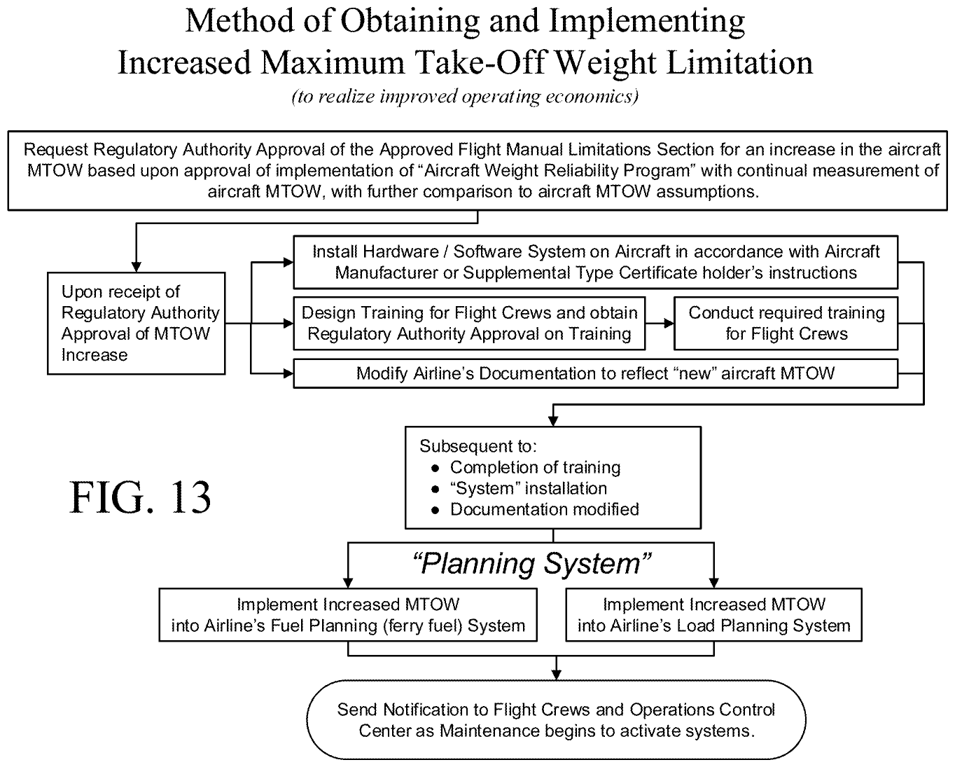

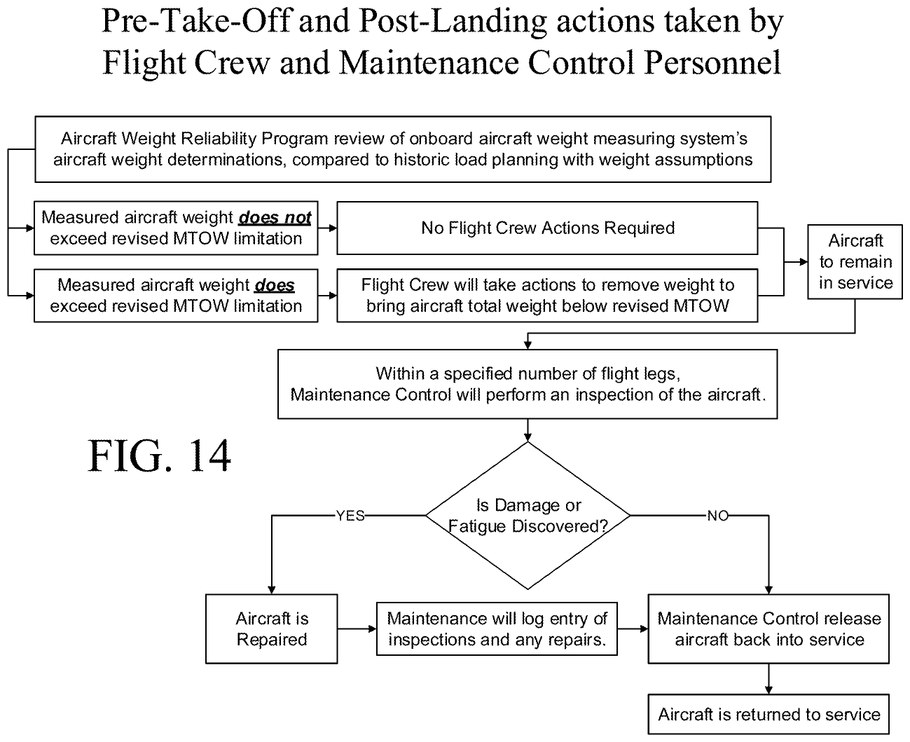

Referring now to FIG. 12 there is shown a first illustration in an extended process design, configured within this first flow-chart for the methodology for obtaining Regulatory Authority Approval for the allowance to periodically measure aircraft weight in order to increase Regulated aircraft weight limitations. This FIG. 12 is followed by FIG. 13 and FIG. 14 which together encapsulate the: justification basis, implementation of system hardware, continued airworthiness and safety procedures with protocols required for aircraft historically using assumed weight values in the determination of aircraft take-off weights, to be allowed to take-off at weights higher than currently certified MTOW limitations, when using a system to measure aircraft weight; where such higher MTOW limitations are no greater than the statistical errors compounded through the use of a variety of un-measured and assumed weights.

The methods on this invention can be extrapolated across the various aircraft weight limitations (MRampW, MTOW, MLW, MZFW) as set by Regulatory Authorities, all of which are determined in some part by the various weight assumptions assigned to male passengers, female passengers, average baggage, heavy baggage and fuel loaded onto the aircraft in various ranges of temperature;

In this FIG. 12, there is shown a view of a process design flow chart for a “Method of Obtaining Relief from Regulated Aircraft MTOW Limitations. Relief to increase MTOW limitations, from the Regulatory Authorities is required for the subsequent operation of the aircraft at a second higher MTOW limitation. In this example: an on-board weighing system being installed onto the aircraft is used for initial computation for the “new” aircraft MTOW limitation, where measured aircraft weights are recorded and compared to respective computed aircraft weights as determined by the LBUM. This process is developed for a particular aircraft type and model, such as with this example, the Boeing 737-800. Once the determination of the amount of increase for the “new” MTOW is made, the allowable weight increase shall be applied to all aircraft of that type and model which utilize an adequate aircraft weight measuring system in conjunction with the prescribed periodic aircraft weighings as stipulated by the Aircraft Weight Reliability Program. For example, the amount of weight increased allowed for the Boeing 737-800 will not be the same amount of allowable weight increase for the Boeing 737-700 aircraft. Though both aircraft are of the same 737 type, they each have different weight limitations.

With the Aircraft Weight Measuring “System” being used to physically measure the aircraft weight, pilots are assured that a gross weight error will not go un-noticed that might create a safety hazard for a particular flight.

Upon the computation of a new increased Max Take-Off Weight limitation, predicated on a recognition of the non-recognized weight errors and subsequently measured aircraft take-off weights, and the apparatus to measure and verify take-off weights on all subsequent take-off events, a system support mechanism is created to document the processes, procedures and limitations for the use of the apparatus and methods of this invention, that Regulatory Authorities are assured an Equivalent Level of Safety is maintained. These include, but are not limited to creating and maintaining Instructions for Continued Airworthiness, addition of an Approved Flight Manual Supplement covering this new aircraft weight measuring system operation, limitations and procedures, as well as operational adjustments in the event the aircraft weight measurement system is inoperable.

Also required is a complete “Documentation of the Justification Basis” for the issuance of an Equivalent Level of Safety, Special Condition, Exemption, or other alternate means of regulatory compliance. These factors include a review of the historical basis of regulatory requirement, along with advancement in technology and operating procedures. Some of these advancements include the development of new systems and procedures that aid pilots in identifying proper aircraft stabilizer and trim settings with systems.

Continued safe operation of the aircraft will be maintained by the subsequently implemented practice of measured aircraft weight determinations being made from measured landing gear load sensor data, rather than weight assumptions made in AC120-27E. Continued safe operation of the aircraft will be maintained by subsequent monitoring of aircraft operational landing loads, at each respective landing gear.

These supporting materials, data and procedures are submitted to the Regulatory Authority as justification for the Regulatory Authority's acknowledgement and approval to allow an increase in MTOW, MRampW, MLW and MZFW limitations equivalent to the amount of non-recognized weight errors allowed by AC120-27E assumptions of a variety of weight elements; to increase the aircraft MTOW, MRampW, MLW and MZFW limitations, with this demonstration of an Equivalent Level of Safety, or other qualifying document. An illustration of the extended process design, configured within this initial flow-chart of the methodology for obtaining Regulatory Authority Approval for the allowance to periodically measure aircraft weight, compared to computed weight, to reveal and document the non-recognized weight errors, as the justification basis to increase Regulated aircraft weight limitations herein is shown within FIG. 12.

Referring now to FIG. 13 there is shown a view of a second process design flow chart for a “Method of Obtaining and Implementing MTOW limitations for aircraft. This additional system support mechanism is created to document the processes, procedures and limitations for the use of the apparatus and methods of this invention, that Regulatory Authorities are assured an Equivalent Level of Safety is maintained. Request is made of the Regulatory Authority to approve modifications to the aircraft's Approved Flight Manual Limitations section regarding the increase in aircraft MTOW limitations. Upon such Flight Manual modification approval, the completion of the installation of the aircraft weight measuring system onto the aircraft, in accordance with respective Supplemental Type Certificate installation requirements; the design of newly modified flight training programs for flight crew and implement such training programs for the use and understanding of the new aircraft weight system are completed. The airline which operates the aircraft with the increased MTOW limitations will modify its documentation for each respective aircraft equipped with the aircraft weight measuring system. The airline operating aircraft with the increased MTOW will amend their “fuel planning programs” for increased opportunities to tanker/ferry more economical fuel; and amend their “load planning programs” in accordance with the prescribed weight increases. When these programs and processes are complete, notification can be made to flight crews and the airline's Operational Control Center, as Maintenance Control activates the aircraft weight systems, fleet-wide. An illustration of this process design, configured within this second flow-chart of the methodology for obtaining and implementing the increased MTOW limitation for Regulated aircraft, herein is shown within FIG. 13.

Referring now to FIG. 14 there is shown view of a process design flow chart, for required pre-take-off and or post-landing actions, to be followed by aircraft Flight Crew and Maintenance Control personnel, upon observance of any weight threshold exceedance indications from periodic weight and CG measurements. This additional system support mechanism is created to document the processes, procedures and limitations for the use of the apparatus and methods of this invention; so that Regulatory Authorities are assured an Equivalent Level of Safety is maintained. In the preferred embodiment of this invention the aircraft weight measuring system will display any aircraft weight “Threshold” exceedance within 4 defined ranges.
1. The first range of measurements will be those of exceeding any revised higher MTOW limitation. If the measured aircraft weight is determined to be higher than the revised higher MTOW (take-off) limitations, steps will be taken to remove weight from the aircraft until the measured weight of the aircraft no longer exceeds the revised higher MTOW limitation. Current weight assumptions can allow an aircraft to exceed the revised higher MTOW limitations and such exceedance will remain unknown. Restrictions precluding aircraft operation beyond the revised higher MTOW limitation offer a “Superior Level of Safety.” If the aircraft weight measuring system is discovered inoperative, the aircraft MTOW limitation shall revert back to its original lower MTOW limitation.
2. The second range of measurements will be those of exceeding any revised higher MLW (landing) limitation. If the measured aircraft weight is determined to be higher than the revised higher MTOW limitations, it shall be assumed that revised higher MLW limitations would be exceeded by an equivalent value. Steps will be taken to remove weight from the aircraft until the measured weight of the aircraft no longer exceeds the revised higher MTOW limitation, thus the planned MLW limitation will remain within the revised higher MLW limitation.
3. The third range of measurements will be those of exceeding any revised higher MZFW (zero-fuel) limitation. If the measured aircraft weight is determined to be higher than the revised higher MTOW limitations, it shall be assumed that revised higher MZFW limitations would be exceeded by an equivalent value. Steps will be taken to remove weight from the aircraft until the measured weight of the aircraft no longer exceeds the revised higher MZFW limitation, thus the planned MZFW limitation will remain within the revised higher MZFW limitation.
4. The fourth range of measurements will be those of exceeding any revised higher MRampW (ramp/taxi) limitation. The Ramp weight is the heaviest assumed weight that the aircraft can be allowed to taxi around the airport. Prior to take-off the aircraft is much heavier, while carrying the additional weight of the fuel anticipated to be used on the flight. If the measured aircraft weight is determined to be higher than the revised higher MTOW limitations, it shall be assumed that revised higher MRampW limitations would be exceeded by an equivalent value. Steps will be taken to remove weight from the aircraft until the measured weight of the aircraft no longer exceeds the revised higher MRampW limitation, thus the planned MRampW limitation will remain within the revised higher MRampW limitation.
   Within a prescribed number of flight legs, the aircraft will be return to a maintenance facility for an inspection of the aircraft for signs that flight operating at the increased weight limitations might create additional fatigue damage to the aircraft. If no damage is found, the aircraft will be returned to service. If damage is discovered, the damage will be repaired, and noted into the aircraft's maintenance log. Additionally, the aircraft may have modifications applied to specific areas of the airframe structure to reinforce and correct for potential future fatigue damage, as noticed from the ongoing aircraft inspections. An illustration of this process design, configured within this third flow-chart of the methodology for periodic inspection to insure continued airworthiness of the aircraft will be maintained with the increased MTOW limitation for Regulated aircraft, herein is shown within FIG. 14.

It is understood that aircraft forward and aft CG limitations are defined and set by the Regulatory Authorities, with such forward and aft limitations based on the assumptions of the various weight components being placed at defined and known locations within the aircraft. Upon determination of the amount of allowed weight increase as a percentage of total aircraft weight (as an example: a 4% weight increase to the MTOW), the equivalent percentage increase (the same 4%) shall be applied to the boundaries of the forward and aft CG limitations.

Described within this invention are methods and strategies developed; in which the whole are now greater than the sum of its parts. Each of the sub-practices of this invention are elements which build upon each other, and strengthen the foundation of justification for the realization that the aircraft design criteria regulations dating back 70 years, have worked well for decades; but the development of new technologies, procedures and the careful implementation and monitoring of such practices offer justification through a finding of an Equivalent Level of Safety, for aviation Regulatory Authorities to allow an increase in the original weight limitations based upon assumed weight values to a second higher weight limitation based upon measure aircraft weight, allow the associated increase to a second set of higher aircraft MRampW, MTOW, MLW and MZFW limitations.

Where previous systems using assumed weight values have been used as a tool to aid pilots with load planning procedures, to help avoid aircraft departures beyond the aircraft safe operational limits, this new invention uses the apparatus and methods to increase the economic value of the aircraft, by bringing to better light that current Regulations are fall short in the accurate determination of aircraft weight and corresponding aircraft CG; and furthermore by measuring monitoring aircraft weights; allows aircraft to operate at an increased MRampW, MTOW, MLW and MZFW limitations . . . to be at an Equivalent Level of Safety.

Although an exemplary embodiment of the invention has been disclosed and discussed, it will be understood that other applications of the invention are possible and that the embodiment disclosed may be subject to various changes, modifications, and substitutions without necessarily departing from the spirit and scope of the invention.

1. A method of obtaining a change to approved weight limits of a regulated aircraft type, wherein a plurality of aircraft of the aircraft type are each capable of carrying a payload and non-payload items, the payload computed using assumed and averaged weight values, the non-payload items based upon indicated weights of the non-payload items, the aircraft type having a first maximum weight limit and a first maximum takeoff weight limit, the method comprising the steps of:
a. For one of the aircraft of the aircraft type, using a computer and modeling programs, simulating plural fully loaded aircraft flights operating near the first maximum weight limit, obtaining statistical and probability data of weight ranges, the statistical and probability data of weight ranges being associated with the assumed and averaged weight values of the payload and the indicated weights of the non-payload items, carried by the aircraft;
b. Repeating step a) for additional simulated flights, determining an increasing range of assumed payload and non-payload weights;
c. For a number of actual flights operating near the first maximum weight limit, obtaining computed data for the assumed weight values of the payload and non-payload items;
d. For the same respective actual flights, comparing the range of statistical and probability data of payload and non-payload weight values, to the computed data for the assumed weight values of the payload and the indicated weights of the non-payload items, and determining a weight difference;
e. For subsequent actual flights of the plurality of aircraft, using an automated system to measure the respective aircraft total weight, and using the determined weight difference, obtaining a second maximum weight limit for the aircraft type and a second maximum takeoff weight limit for the aircraft type, the second maximum weight limit being more than the first maximum weight limit and the second maximum takeoff weight limit being more than the first maximum takeoff weight limit;
f. Determining a difference between the first maximum takeoff weight limit and the second maximum takeoff weight limit;
g. For further subsequent actual flights, using an automated system to measure the respective total aircraft weight, while operating the aircraft of the aircraft type at weights within the second maximum weight limit.

2. The method of claim 1, further comprising the step of, using the difference between the first maximum takeoff weight limit and the second maximum takeoff weight limit, identifying the second maximum takeoff weight as a percentage of the first maximum takeoff weight limit.

3. The method of claim 1, the regulated aircraft type having a first maximum landing weight limit, the method further comprising the step of, using the second maximum takeoff weight limit, determining a second maximum landing weight limit.

4. The method of claim 3, the second maximum landing weight limit identified as a percentage of the aircraft first maximum takeoff weight limit.

5. The method of claim 1, the regulated aircraft type having a first maximum zero-fuel weight limit, the method further comprising the step of, using the second maximum takeoff weight limit, determining a second maximum zero-fuel weight limit.

6. The method of claim 5, the second maximum zero-fuel weight limit, identified as a percentage of the first maximum takeoff weight limit.

7. The method of claim 1, the regulated aircraft type having a first maximum ramp weight limit, the method further comprising the step of, using the second maximum takeoff weight limit, determining a second maximum ramp weight limit.

8. The method of claim 7, the second maximum ramp weight limit identified as a percentage of the first maximum takeoff weight limit.
